(19) United States
(12) Patent Application Publication
(10) Pub. No.: US 2026/0159100 A1
(43) Pub. Date: Jun. 11, 2026

(54) SENSOR VERIFICATION DEVICE, SENSOR VERIFICATION SYSTEM, AND SENSOR VERIFICATION METHOD

(71) Applicants: Sony Group Corporation, Tokyo (JP); Sony Semiconductor Solutions Corporation, Kanagawa (JP)

(72) Inventors: Junichi Sakamoto, Kanagawa (JP); Kazuyuki Shimezawa, Kanagawa (JP)

(73) Assignees: Sony Group Corporation, Tokyo (JP); Sony Semiconductor Solutions Corporation, Kanagawa (JP)

(21) Appl. No.: 18/707,957

(22) PCT Filed: Oct. 13, 2022
(86) PCT No.: PCT/JP2022/038179

§ 371 Date: May 7, 2024

(30) Foreign Application Priority Data
Nov. 17, 2021 (JP) 2021-186811

(51) Int. Cl. B60W 50/02

(52) U.S. Cl. CPC B60W 50/0205; B60W 2050/0215; B60W 2556/45

(57) ABSTRACT

Provided are a device and a method that enable high-frequency sensor calibration by frequently verifying whether or not a sensor can calculate a normal distance. A distance between an own vehicle and an external vehicle or a distance between an own vehicle and an infrastructure is calculated as own device calculated distance data D1 on the basis of a detection value of a sensor such as a stereo camera, a device-to-device distance calculated by an external device is received from the external device as external device calculated distance data D2, and the own device calculated distance data D1 and the external device calculated distance data D2 are compared to determine whether or not the sensor is in a state capable of measuring a correct distance value on the basis of a comparison result. In a case where it is determined that the sensor is not in a state capable of measuring a correct distance value, a sensor calibration process or a failure detection process is executed.

### TECHNICAL FIELD

The present disclosure relates to a sensor verification device, a sensor verification system, and a sensor verification method. More specifically, the present disclosure relates to a sensor verification device, a sensor verification system, and a sensor verification method for determining whether or not a sensor for distance measurement mounted on a vehicle is executing correct distance measurement.

### BACKGROUND ART

Recently, technology development related to automated driving and driving support has been actively conducted. For example, advanced driver assistance system (ADAS), autonomous driving (AD) technology, and the like are used. Automated driving and driving support are technologies that enable automated traveling on a road using various sensors such as a camera and an object position detection sensor provided in a vehicle (automobile), and it is predicted that automated driving and driving support will rapidly spread in the future.

Automated driving and driving support use detection information of various sensors such as a camera and a radar.

Specifically, for example, a stereo camera or the like is used as a sensor that calculates a distance from a vehicle to various objects such as an oncoming vehicle, a pedestrian, or a guardrail in a vehicle traveling direction.

However, in a sensor such as a camera mounted on a vehicle, a deviation of an attachment position, distortion, or the like occurs due to vibration, a temperature change, or the like generated in a traveling process of the vehicle, and as a result, sensor performance may be deteriorated, for example, distance measurement performance may be deteriorated.

The inspection as to whether or not the operation of the sensor mounted on the vehicle is normal can be performed, for example, by using a dedicated inspection machine at a dealer or the like at the time of periodic vehicle inspection or the like.

However, such a periodic inspection is generally performed only every half year or every several years, and there is a possibility that the sensor does not normally operate before the inspection date. In such a case, normal automated driving cannot be performed, and there is a risk of causing an accident.

In order to perform highly safe automated driving and driving support, it is preferable to execute verification of whether or not the sensor is normally operating at a higher frequency.

Note that, for example, Patent Document 1 (Japanese Patent Application Laid-Open No. 2020-042323) as a conventional technique discloses a technique for confirming and correcting an error of a camera mounted on a vehicle.

This Patent Document 1 discloses a configuration in which a plurality of vehicles travels in line, and a following vehicle performs automated driving control for maintaining a constant relative position with respect to a preceding vehicle. Specifically, the present disclosure discloses a configuration for calculating a correct vehicle relative position by comparing vehicle relative position information of a preceding vehicle and a following vehicle calculated on the basis of an image of the preceding vehicle captured by the following vehicle with vehicle relative position information of the preceding vehicle and the following vehicle calculated on the basis of a following vehicle image captured by the preceding vehicle.

However, the configuration disclosed in Patent Document 1 is a configuration that can be used only in a case where a special traveling condition in which a plurality of vehicles performs platoon traveling is satisfied, and is not a configuration that can be applied to control of a large number of randomly traveling vehicles or a verification process of a sensor operation state mounted on the vehicle.

### CITATION LIST

### Patent Document

Patent Document 1: Japanese Patent Application Laid-Open No. 2020-042323

### SUMMARY OF THE INVENTION

### Problems to be Solved by the Invention

The present disclosure has been made in view of the above-described problems, for example, and an object thereof is to provide a sensor verification device, a sensor verification system, and a sensor verification method capable of efficiently and frequently verifying whether or not sensors mounted on a large number of randomly traveling vehicles measure correct distances.

### Solutions to Problems

A first aspect of the present disclosure is
a sensor verification device including:
a distance calculation unit that calculates a device-to-device distance between an own device and an external device as own device calculated distance data D1 on the basis of a detection value of a sensor;
a communication unit that receives the device-to-device distance calculated by the external device from the external device as external device calculated distance data D2; and
a sensor state determination unit that compares the own device calculated distance data D1 with the external device calculated distance data D2 and determines whether or not the sensor is in a state capable of measuring a correct distance value on the basis of a comparison result.

Further, a second aspect of the present disclosure is
a sensor verification system including an own vehicle and an external device,
in which the external device is either an external vehicle or an infrastructure, and
the own vehicle includes:
a distance calculation unit that calculates a device-to-device distance between the own vehicle and the external device as own device calculated distance data D1 on the basis of a detection value of a sensor;
a communication unit that receives the device-to-device distance calculated by the external device from the external device as external device calculated distance data D2; and
a sensor state determination unit that compares the own device calculated distance data D1 with the external device calculated distance data D2, determines whether or not the sensor is in a state capable of measuring a correct distance value on the basis of a comparison result, and notifies the external device of the comparison result.

Further, a third aspect of the present disclosure is
a sensor verification method executed in a sensor verification device, the sensor verification method including:
a distance calculation step of calculating, by a distance calculation unit, a device-to-device distance between an own device and an external device as own device calculated distance data D1 on the basis of a detection value of a sensor;
a communication step of receiving, by a communication unit, the device-to-device distance calculated by the external device from the external device as external device calculated distance data D2; and
a sensor state determination step of comparing, by a sensor state determination unit, the own device calculated distance data D1 with the external device calculated distance data D2, and determining whether or not the sensor is in a state capable of measuring a correct distance value on the basis of a comparison result.

Other objects, features, and advantages of the present disclosure will become apparent from a more detailed description based on embodiments of the present disclosure described below and the accompanying drawings. Note that, in the present specification, a system is a logical set configuration of a plurality of devices, and is not limited to a system in which devices of respective configurations are in the same housing.

According to a configuration of an embodiment of the present disclosure, it is possible to implement a device and a method that enable high-frequency sensor calibration by frequently verifying whether or not a sensor can calculate a normal distance.

Specifically, for example, a distance between an own vehicle and an external vehicle or a distance between an own vehicle and an infrastructure is calculated as own device calculated distance data D1 on the basis of a detection value of a sensor such as a stereo camera, a device-to-device distance calculated by an external device is received from the external device as external device calculated distance data D2, and the own device calculated distance data D1 and the external device calculated distance data D2 are compared to determine whether or not the sensor is in a state capable of measuring a correct distance value on the basis of a comparison result. In a case where it is determined that the sensor is not in a state capable of measuring a correct distance value, a sensor calibration process or a failure detection process is executed.

With this configuration, a device and a method are implemented that enable high-frequency sensor calibration by frequently verifying whether or not a sensor can calculate a normal distance.

Note that the effects described herein are merely examples and are not limited, and additional effects may also be provided.

### BRIEF DESCRIPTION OF DRAWINGS

FIG. 1 is a diagram for explaining an outline of a sensor verification process of the present disclosure.

FIG. 2 is a diagram for explaining an outline of a sensor verification process of the present disclosure.

FIG. 3 is a diagram for explaining an outline of a sensor verification process of the present disclosure.

FIG. 4 is a block diagram illustrating a configuration example of a sensor verification device mounted in a vehicle or an infrastructure.

FIG. 5 is a diagram for explaining a configuration example of a large number of infrastructures grounded on a road, a management server, and a communication network.

FIG. 6 is a diagram for explaining a specific example of a periodic calibration process of an infrastructure.

FIG. 7 is a diagram illustrating a flowchart for explaining a sequence of processing executed by the sensor verification device of the present disclosure.

FIG. 8 is a diagram illustrating a flowchart for explaining a sequence of processing executed by the sensor verification device of the present disclosure.

FIG. 9 is a diagram for explaining an example of data recorded in a memory by a sensor verification device of a vehicle.

FIG. 10 is a diagram for explaining an example of reception data from an external device recorded in a memory by a sensor verification device of a vehicle.

FIG. 11 is a diagram illustrating a flowchart for explaining a sequence of a calibration process executed by the sensor verification device.

FIG. 12 is a diagram illustrating a flowchart for explaining a sequence of a calibration process executed by the sensor verification device.

FIG. 13 is a diagram for explaining an example of a communication sequence between a vehicle A and a vehicle B.

FIG. 14 is a diagram for explaining an example of a communication sequence between a vehicle A and an infrastructure.

FIG. 15 is a diagram for explaining an example of a communication sequence between a vehicle A and an infrastructure.

FIG. 16 is a diagram for explaining processing of a second embodiment in which processing of storing an LR image captured by a stereo camera in a memory 104 is not executed.

FIG. 17 is a diagram illustrating a flowchart for explaining a sequence of a sensor calibration process in the second embodiment.

FIG. 18 is a diagram for explaining details of processing of calculating an object distance from a captured image of a monocular camera.

FIG. 19 is a diagram illustrating an example of a lookup table recording a correspondence relationship between the number of pixels from a vanishing point position to an object grounding position in a captured image of a monocular camera and a distance from the monocular camera to an object.

FIG. 20 is a diagram for explaining a specific example in which a marker is set to clarify a distance calculation target position.

FIG. 21 is a diagram for explaining an example of a distance calculation process in a case where a marker indicating a distance measurement position is set in an infrastructure.

FIG. 22 is a diagram for explaining an example in which a distance calculation section between a vehicle and an infrastructure is defined by a marker set in an infrastructure and a line position predefined near an intersection.

FIG. 23 is a diagram for explaining an example in which the sensor verification device of the present disclosure is configured in various devices other than a vehicle and an infrastructure (road facility).

FIG. 24 is a diagram for explaining a hardware configuration example of the sensor verification device of the present disclosure.

### MODE FOR CARRYING OUT THE INVENTION

Hereinafter, details of a sensor verification device, a sensor verification system, and a sensor verification method of the present disclosure will be described with reference to the drawings. Note that the description will be made in accordance with the following items.
1. (First Embodiment) Outline of Sensor Verification Process of Present Disclosure
2. Configuration Example of Sensor Verification Device Configured in Vehicle, Infrastructure, and Like
3. Sequence of Processing Executed by Sensor Verification Device of Present Disclosure
4. Communication Sequences Between Vehicles and Between Vehicle and Infrastructure
5. (Second Embodiment) Embodiment in Which Calibration Is Performed Without Recording Image That Is Sensor Detection Information at Time of Distance Measurement
6. (Third Embodiment) Embodiment Using Monocular Camera as Sensor
7. (Fourth Embodiment) Embodiment in Which Marker Is Set to Clarify Distance Calculation Target Position
8. Other Embodiments
9. Hardware Configuration Example of Sensor Verification Device of Present Disclosure
10. Summary of Configuration of Present Disclosure

### 1. (First Embodiment) Outline of Sensor Verification Process of Present Disclosure

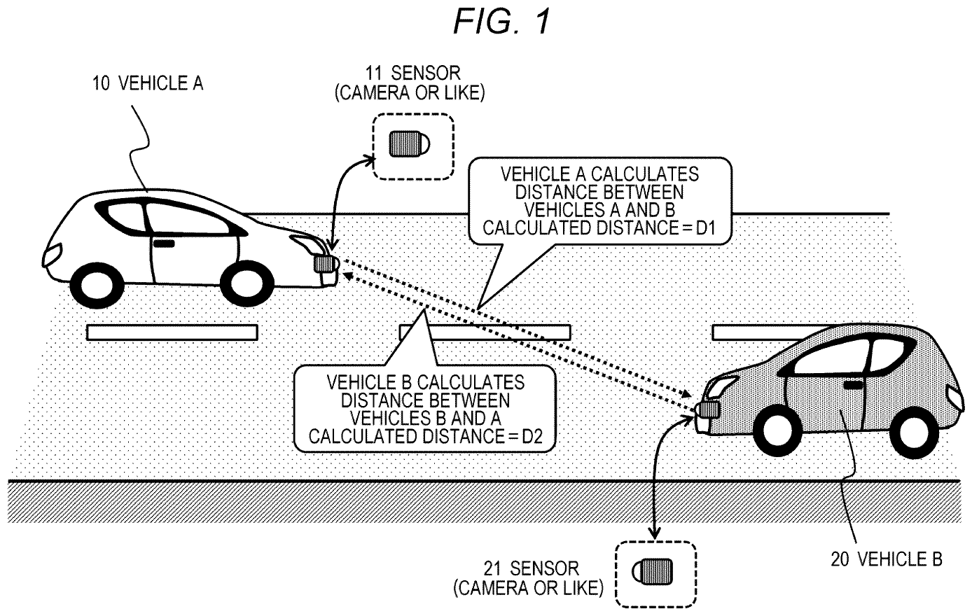

An outline of a sensor verification process of the present disclosure will be described with reference to FIG. 1 and subsequent drawings.

FIG. 1 is a diagram illustrating an example of a sensor verification process of the present disclosure.

FIG. 1 illustrates two vehicles passing each other, a vehicle A, 10 and a vehicle B, 20.

A sensor 11 that detects distances to various objects existing in the front direction of the vehicle A, 10 is attached to the vehicle A, 10.

A sensor 21 that detects distances to various objects existing in the front direction of the vehicle B, 20 is also attached to the vehicle B, 20.

These sensors 11 and 21 are configured by, for example, a stereo camera.

The stereo camera is a type of distance detection sensor that captures a plurality of images from different viewpoints, analyzes parallaxes of the images captured from the plurality of different viewpoints, for example, an L image as a captured image from a left viewpoint and an R image as a captured image from a right viewpoint, and analyzes a distance to a subject included in the captured image.

Note that the sensors 11 and 21 are not limited to stereo cameras, and various sensors capable of measuring a distance can be used.

For example, a light detection and ranging (LiDAR) sensor, a time of flight (ToF) sensor, a sensor such as a millimeter wave radar, a monocular camera, or the like can also be used.

Note that a light detection and ranging (LiDAR) sensor, a ToF sensor, and a millimeter wave radar are sensors that output light such as laser light, for example, and analyze reflected light by an object to measure a distance to a surrounding object.

In the first embodiment described below, an example in a case where a stereo camera is used as the sensors 11 and 21 will be described.

The vehicle A, 10 illustrated in FIG. 1 includes a data processing unit (distance calculation unit) that inputs an image of a stereo camera which is the sensor 11 of the vehicle A, 10 and calculates distances of various objects in front of the vehicle A, 10.

However, in a sensor such as a camera mounted on a vehicle, a deviation of an attachment position, distortion, or the like occurs due to vibration, a temperature change, or the like generated in a traveling process of the vehicle, and as a result, sensor performance may be deteriorated, for example, distance measurement performance may be deteriorated.

The vehicle A, 10 performs a series of processes described below as a process of determining whether or not the object distance calculated on the basis of the captured image of the stereo camera which is the sensor 11 of the vehicle A, 10 is a correct value, that is, a sensor verification process.

First, the vehicle A, 10 continuously executes a calculation process of the distance between the vehicles A and B based on the detection value (stereo camera-captured image) of the sensor 11 of the vehicle A, 10, and records time-series data of the calculated distance in the memory together with a time stamp indicating distance calculation timing.

Note that the time stamp is assigned using accurate time information received by the vehicle A, 10 from a time server such as a network time protocol (NTP) server, for example.

In the memory, for example, a detection value (stereo camera-captured image) of the sensor 11, calculated distance data, and a time stamp are recorded in association with each other.

Further, the vehicle A, 10 requests the vehicle B, 20 to perform the calculation process of the distance between the vehicles A and B via the communication unit. Specifically, for example, the following processing request is transmitted to the vehicle B, 20.

Processing request=a processing request for a calculation process of a distance between the vehicles A and B and a process of transmitting the calculated distance data (D2) to the vehicle A, 10 together with a time stamp indicating a calculation timing of the distance data (D2),

Note that, also in the vehicle B, 20, the time stamp is accurate time information received from a time server such as a network time protocol (NTP) server, for example.

The vehicle A, 10 receives, from the vehicle B, 20, the distance data (D2) between the vehicles A and B calculated by the vehicle B, 20 together with a time stamp indicating the calculation timing.

Thereafter, the vehicle A, 10 selects and acquires distance data (D1) in which a time stamp at the same timing as the time stamp set in the distance data (D2) received from the vehicle B, 20 is set from the time-series distance data between the vehicles A and B continuously calculated by the vehicle A, 10 stored in the memory, and compares the distance data (D1).

In a case where the sensor 11 and the distance calculation unit of the vehicle A, 10 are in a normal state and the sensor 21 of the vehicle B, 20 and the distance calculation unit are also in a normal state, the distance data (D1) between the vehicles A and B calculated by the vehicle A, 10 and the distance data (D2) between the vehicles A and B calculated by the vehicle B, 20 have a substantially equal value.

That is,

$$D 1 \approx D 2$$

the above formula is satisfied.

However, in a case where at least one of the sensor 11 or the distance calculation unit of the vehicle A, 10 or the sensor 21 or the distance calculation unit of the vehicle B, 20 is in a state where normal distance calculation has not been performed, the distance data (D1) between the vehicles A and B calculated by the vehicle A, 10 and the distance data (D2) between the vehicles A and B calculated by the vehicle B, 20 do not have an equal value.

That is,

$$D 1 \approx D 2$$

the above formula is not satisfied.

In this case, the vehicle A, 10 can determine that at least one of the sensor 11 or the distance calculation unit of the vehicle A, 10 or the sensor 21 or the distance calculation unit of the vehicle B, 20 is not in a normal state.

In such a case, the vehicle A, 10 then executes, for example, a process similar to that of another vehicle C. That is, in each of the vehicles A and C, the distance between the vehicles A and C are calculated and compared at the same timing.

When the distance between the vehicles A and C at the same timing calculated in the respective vehicles A and C are substantially the same, the vehicle A, 10 can determine that the sensor 11 and the distance calculation unit of the vehicle A, 10 are normally operating and the sensor 21 and the distance calculation unit of the vehicle B, 20 are not normally operating.

On the other hand, in a case where the distance between the vehicles A and C at the same timing calculated in the respective vehicles A and C do not match, the vehicle A, 10 determines that the sensor 11 and the distance calculation unit of the vehicle A, 10 themselves are not normally operating.

In this case, the vehicle A, 10 performs a calibration process of the sensor 11, that is, a correction process. Specifically, for example, internal parameters (focal length, distortion, image center) and external parameters (position and posture) of the sensor 11 are adjusted, and a calibration process (correction process) is executed so that a correct distance can be calculated.

Note that the example illustrated in FIG. 1 is configured to determine whether or not the sensor and the distance calculation unit are normally operating using distance data measured at the same timing between two vehicles. However, a configuration may be employed in which a mutual distance is simultaneously calculated between a vehicle and an infrastructure on a road, for example, an infrastructure such as a traffic light, and these calculated values are compared.

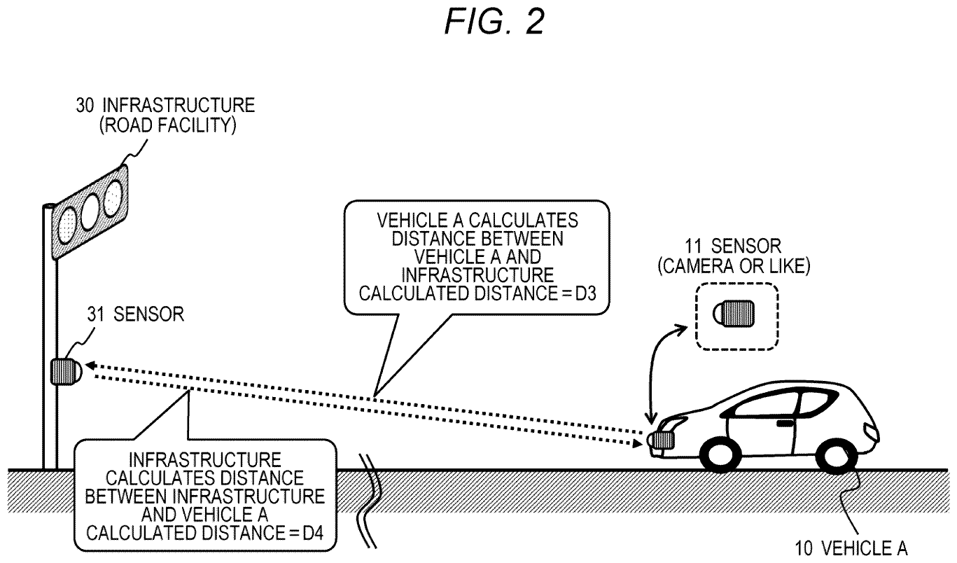

With reference to FIG. 2, an example of a case of performing a process of simultaneously calculating a mutual distance between a vehicle and an infrastructure such as a traffic light on a road and comparing these calculated values will be described.

FIG. 2 illustrates the vehicle A, 10 and a traffic light as an example of an infrastructure (road facility) 30.

The vehicle A, 10 is the vehicle described with reference to FIG. 1, and is mounted with the sensor 11 that detects distances to various objects existing in the front direction of the vehicle A, 10.

A sensor 31 that detects distances to various objects existing around the infrastructure (road facility) 30 is also attached to the infrastructure (road facility) 30. These sensors 11 and 31 are, for example, stereo cameras.

Each of the vehicle A, 10 and the infrastructure (road facility) 30 illustrated in FIG. 2 includes a data processing unit (distance calculation unit) that inputs an image of a sensor (stereo camera) and calculates distances of various objects.

The vehicle A, 10 performs the following process as a process of determining whether or not the object distance calculated on the basis of the captured image of the stereo camera which is the sensor 11 of the vehicle A, 10 is a correct value, that is, a sensor verification process.

First, the vehicle A, 10 continuously executes a calculation process of the distance between the vehicle A, 10 and the infrastructure 30 based on the detection value (stereo camera-captured image) of the sensor 11 of the vehicle A, 10, and records time-series data of the calculated distance in the memory together with the time stamp indicating the distance calculation timing.

Note that, as the time stamp, accurate time information received by the vehicle A, 10 from a time server such as a network time protocol (NTP) server is used.

Further, the vehicle A, 10 transmits the following processing request to the infrastructure 30 via the communication unit.

Processing request=a processing request for a calculation process of a distance between the vehicle A, 10 and the infrastructure 30 and a process of transmitting the calculated distance data (D4) to the vehicle A, 10 together with a time stamp indicating a calculation timing of the distance data (D4),

Note that the infrastructure 30 also uses accurate time information received from a time server such as a network time protocol (NTP) server, for example, as the time stamp.

The vehicle A, 10 receives, from the infrastructure 30, the distance data (D4) between the vehicle A, 10 and the infrastructure 30 calculated by the infrastructure 30 together with the time stamp indicating the calculation timing.

Thereafter, the vehicle A, 10 selects and acquires distance data (D3) in which a time stamp at the same timing as the time stamp set in the distance data (D4) received from the infrastructure 30 is set from the time-series distance data between the vehicle A, 10 and the infrastructure 30 continuously calculated by the vehicle A, 10 stored in the memory, and compares the distance data (D3).

In a case where the sensor 11 and the distance calculation unit of the vehicle A, 10 are in a normal state and the sensor 31 and the distance calculation unit of the infrastructure 30 are also in a normal state, the distance data (D3) between the vehicle A, 10 and the infrastructure 30 calculated by the vehicle A, 10 and the distance data (D4) between the vehicle A, 10 and the infrastructure 30 calculated by the infrastructure 30 have a substantially equal value.

That is,

$$D 3 \approx D 4$$

the above formula is satisfied.

However, in a case where at least one of the sensor 11 or the distance calculation unit of the vehicle A, 10 or the sensor 31 or the distance calculation unit of the infrastructure 30 is not in a normal state, the distance data (D3) between the vehicle A, 10 and the infrastructure 30 calculated by the vehicle A, 10 and the distance data (D4) between the vehicle A, 10 and the infrastructure 30 calculated by the infrastructure 30 do not have equal values.

That is,

$$D 3 \approx D 4$$

the above formula is not satisfied.

In this case, the vehicle A, 10 can determine that at least one of the sensor 11 or the distance calculation unit of the vehicle A, 10 or the sensor 31 or the distance calculation unit of the infrastructure 30 is not in a normal state.

However, in a case where the infrastructure 30 is set to be able to communicate with, for example, an external management server and is an infrastructure managed by the management server, it is possible to periodically calibrate the sensor 31 and the distance calculation unit of the infrastructure 30 by the control of the management server.

The infrastructure 30 such as a traffic light is fixed on the ground, and for example, a distance to another traffic light on the opposite side of the road is stored as reference distance data in a management server or a memory in the infrastructure 30, and the sensor 31 and the distance calculation unit of the infrastructure 30 can be periodically calibrated using the reference distance data.

In a case where the infrastructure 30 is an infrastructure managed by the management server in this manner, the sensor 31 and the distance calculation unit of the infrastructure 30 can always maintain a setting capable of calculating normal distance data.

In a case where the infrastructure 30 is managed by the management server in this manner and is an infrastructure maintained in a setting capable of calculating normal distance data at all times, in a case where the distance data (D3) between the vehicle A, 10 and the infrastructure 30 calculated by the vehicle A, 10 and the distance data (D4) between the vehicle A, 10 and the infrastructure 30 calculated by the infrastructure 30 are not equal, that is,

$$D 3 \approx D 4$$

in a case where the above formula is not satisfied, the vehicle A, 10 can determine that the sensor 11 and the distance calculation unit of the vehicle A, 10 are not in a normal state.

In this case, the vehicle A, 10 performs a calibration process of the sensor 11, that is, a correction process. Specifically, for example, internal parameters (focal length, distortion, image center) and external parameters (position and posture) of the sensor 11 are adjusted, and a calibration process (correction process) is executed so that a correct distance can be calculated.

A processing example between vehicles has been described with reference to FIG. 1, and a processing example between a vehicle and an infrastructure has been described with reference to FIG. 2.

While traveling on the road, the vehicle will encounter a large number of vehicles and infrastructures, and it is possible to verify the operation state of the sensor of the own vehicle at any of these timings.

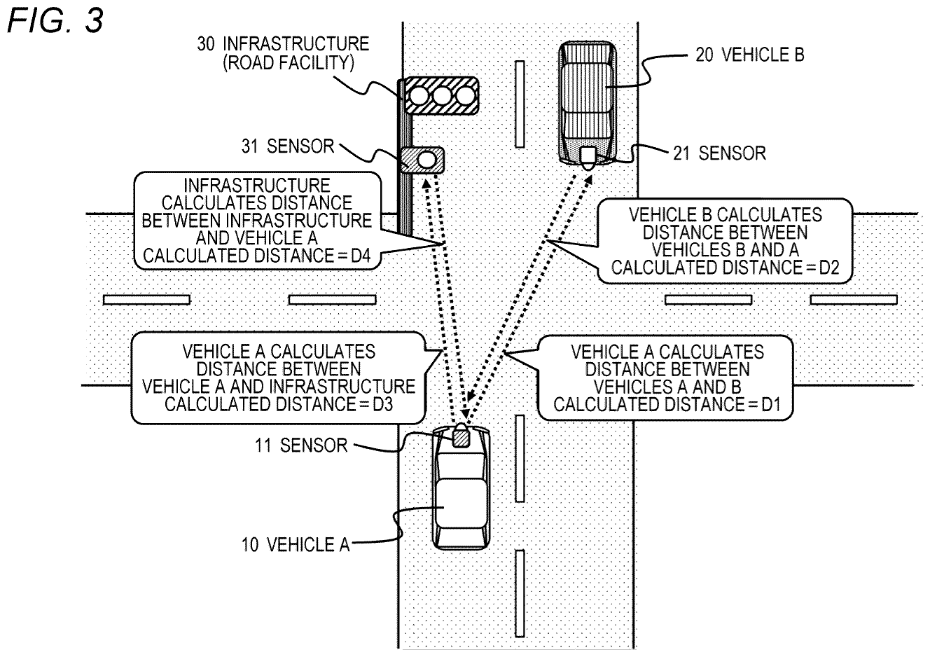

FIG. 3 is a diagram illustrating a processing example in which the vehicle A, 10 verifies the operation states of the sensor 11 and the distance calculation unit of the own vehicle while the vehicle A, 10 is waiting for a traffic light at an intersection.

The vehicle A, 10 executes the process described above with reference to FIG. 1 with the vehicle B, 20. Further, the vehicle A, 10 executes the process described above with reference to FIG. 2 with the infrastructure 30. These two processes may be sequentially executed sequentially or may be executed in parallel.

For example, the vehicle A, 10 performs the following process.

The vehicle A, 10 continuously executes the calculation process of the distance between the vehicles A and B based on the detection value (stereo camera-captured image) of the sensor 11 of the vehicle A, 10, and records time-series data of the calculated distance in a memory together with a time stamp indicating distance calculation timing.

Next, the vehicle A, 10 transmits the following processing request to the vehicle B, 20 via the communication unit.

Processing request=a processing request for a calculation process of a distance between the vehicles A and B and a process of transmitting the calculated distance data (D2) to the vehicle A, 10 together with a time stamp indicating a calculation timing of the distance data (D2),

The vehicle A, 10 receives, from the vehicle B, 20, the distance data (D2) between the vehicles A and B calculated by the vehicle B, 20 together with a time stamp indicating the calculation timing.

Thereafter, the vehicle A, 10 selects and acquires distance data (D1) in which a time stamp at the same timing as the time stamp set in the distance data (D2) received from the vehicle B, 20 is set from the time-series distance data between the vehicles A and B continuously calculated by the vehicle A, 10 stored in the memory, and compares the distance data (D1).

In a case where the sensor 11 and the distance calculation unit of the vehicle A, 10 are in a normal state and the sensor 21 of the vehicle B, 20 and the distance calculation unit are also in a normal state, the distance data (D1) between the vehicles A and B calculated by the vehicle A, 10 and the distance data (D2) between the vehicles A and B calculated by the vehicle B, 20 have a substantially equal value.

That is,

$$D 1 \approx D 2$$

the above formula is satisfied.

Further, the vehicle A, 10 transmits the following processing request to the infrastructure 30 via the communication unit.

Processing request=a processing request for a calculation process of a distance between the vehicle A, 10 and the infrastructure 30 and a process of transmitting the calculated distance data (D4) to the vehicle A, 10 together with a time stamp indicating a calculation timing of the distance data (D4),

The vehicle A, 10 receives, from the infrastructure 30, the distance data (D4) between the vehicle A, 10 and the infrastructure 30 calculated by the infrastructure 30 together with the time stamp indicating the calculation timing.

Thereafter, the vehicle A, 10 selects and acquires distance data (D3) in which a time stamp at the same timing as the time stamp set in the distance data (D4) received from the infrastructure 30 is set from the time-series distance data between the vehicle A, 10 and the infrastructure 30 continuously calculated by the vehicle A, 10 stored in the memory, and compares the distance data (D3).

In a case where the sensor 11 and the distance calculation unit of the vehicle A, 10 are in a normal state and the sensor 31 and the distance calculation unit of the infrastructure 30 are also in a normal state, the distance data (D3) between the vehicle A, 10 and the infrastructure 30 calculated by the vehicle A, 10 and the distance data (D4) between the vehicle A, 10 and the infrastructure 30 calculated by the infrastructure 30 have a substantially equal value.

That is,

$$D 3 \approx D 4$$

the above formula is satisfied.

In these two processes,

$$D 1 \approx D 2$$

$$D 3 \approx D 4$$

in a case where it is confirmed that these two formulas are satisfied, the vehicle A, 10 can determine that the sensor 11 and the distance calculation unit of the vehicle A, 10, the sensor 21 and the distance calculation unit of the vehicle B, 20, and the sensor 31 and the distance calculation unit of the infrastructure 30 are all in a normal state.

However, for example, as a comparison result of the distance calculation values (D1, D2) between the vehicles A and B,

$$D 1 \approx D 2$$

in a case where the above formula is not satisfied, and as a comparison result of the distance calculation values (D3, D4) between the vehicle A and the infrastructure,

$$D 3 \approx D 4$$

in a case where the above formula is satisfied, the vehicle A, 10 can determine that the sensor 11 and the distance calculation unit of the vehicle A, 10 are normal, but the sensor 21 and the distance calculation unit of the vehicle B, 20 are not normal.

In this case, the vehicle A, 10 notifies the vehicle B, 20 of a warning that the sensor 21 and the distance calculation unit of the vehicle B, 20 are not operating normally.

The vehicle B, 20 detects that the sensor 21 and the distance calculation unit of the vehicle B, 20 are not operating normally on the basis of the reception of the warning notification, and can perform calibration (correction process) of the sensor 21 and the distance calculation unit of the vehicle B, 20 and repair processing of a failure without delay.

### 2. Configuration Example of Sensor Verification Device Configured in Vehicle, Infrastructure, and Like

Next, a configuration example of a sensor verification device configured in a vehicle, an infrastructure, or the like that executes the above process will be described.

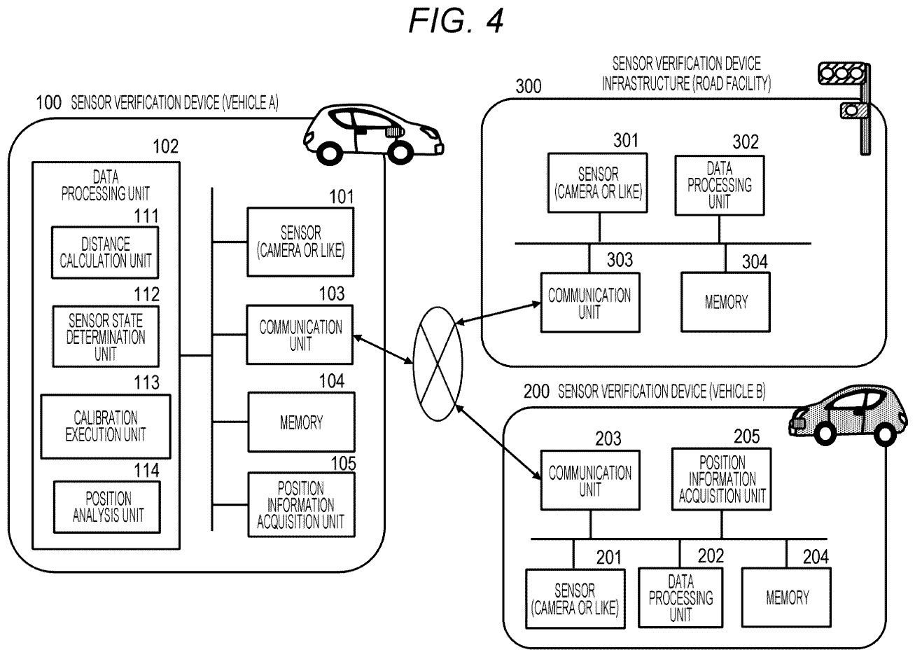

FIG. 4 is a block diagram illustrating a configuration example of a sensor verification device mounted in a vehicle or an infrastructure that executes the above process.

FIG. 4 is a block diagram illustrating a configuration example of sensor verification devices mounted in the vehicle A, 10, the vehicle B, 20, and the infrastructure (road facility) 30 illustrated in FIG. 3.

As illustrated in FIG. 4, a sensor verification device 100 of the vehicle A, 10 includes a sensor 101, a data processing unit 102, a communication unit 103, a memory 104, and a position information acquisition unit 105.

The data processing unit 102 includes a distance calculation unit 111, a sensor state determination unit 112, a calibration execution unit 113, and a position analysis unit 114.

A sensor verification device 200 of the vehicle B, 20 has a configuration similar to the sensor verification device 100 of the vehicle A, and includes a sensor 201, a data processing unit 202, a communication unit 203, a memory 204, and a position information acquisition unit 205.

Note that, although not illustrated, the data processing unit 202 of the vehicle B, 20 also includes a distance calculation unit, a sensor state determination unit, a calibration execution unit, and a position analysis unit.

A sensor verification device 300 of the infrastructure (road facility) 30 includes a sensor 301, a data processing unit 302, a communication unit 303, and a memory 304.

Note that, although not illustrated, the data processing unit 302 of the infrastructure (road facility) 30 includes a distance calculation unit, a sensor state determination unit, and a calibration execution unit.

First, each configuration of the sensor verification device 100 of the vehicle A, 10 will be described.

As described above, the sensor 101 includes, for example, a stereo camera.

The stereo camera is a type of distance detection sensor capable of capturing a plurality of images from different viewpoints, analyzing parallax of the plurality of captured images, and analyzing a distance to a subject included in the captured image.

Note that the sensor 101 is not limited to a stereo camera, and various sensors capable of measuring a distance can be used.

For example, as described above, a light detection and ranging (LiDAR) sensor, a time of flight (ToF) sensor, a sensor such as a millimeter wave radar, a monocular camera, or the like can also be used.

Note that a light detection and ranging (LiDAR) sensor, a ToF sensor, and a millimeter wave radar are sensors that output light such as laser light, for example, and analyze reflected light by an object to measure a distance to a surrounding object.

The data processing unit 102 includes a distance calculation unit 111, a sensor state determination unit 112, a calibration execution unit 113, and a position analysis unit 114.

The distance calculation unit 111 inputs detection information of the sensor 101, for example, a plurality of captured images and the like captured from different viewpoints constituting the stereo camera, and calculates the distance to the subject in the camera-captured image.

For example, a distance to the vehicle B, 20 which is an oncoming vehicle illustrated in FIG. 3, a distance to the infrastructure (road facility) 30 which is a traffic light, and the like are calculated.

Note that the object distance data calculated by the distance calculation unit 111 is recorded in the memory 104 in association with the time stamp indicating the distance calculation time.

The sensor state determination unit 112 executes a process of comparing distance data calculated by the distance calculation unit 111 in the data processing unit 102 on the basis of an input value (such as a captured image of a stereo camera) from the sensor 101 with distance data received from another device via the communication unit 103, and determines whether or not the sensor 101 is in a state of being able to calculate normal distance data on the basis of a comparison result.

Note that the distance data to be compared is distance data between the vehicle A, 10 and another device (vehicle B, 20 or infrastructure 30) calculated by the vehicle A, 10 and the other device (vehicle B, 20 or infrastructure 30) at the same time.

That is, the sensor state determination unit 112 inputs the object distance (distance between the vehicle A, 10 and the vehicle B, 20, or distance between the vehicle A, 10 and the infrastructure 30) calculated on the basis of the sensor detection value of each device by the vehicle B, 20 or the infrastructure (road facility) 30 illustrated in FIG. 3 via the communication unit 103, and compares the distance data received from the other device with the distance data calculated on the basis of the input value (such as the captured image of the stereo camera) from the sensor 101 by the distance calculation unit 111.

Further, on the basis of the comparison result, it is determined whether or not the sensor 101 is in a state capable of calculating normal distance data.

In a case where the calibration execution unit 113 determines that the sensor 101 or the distance calculation unit 111 of the vehicle A, 10 is not normally operating on the basis of the result of the distance comparison process in the sensor state determination unit 112 described above, the calibration execution unit executes the correction process of the sensor 101 or the distance calculation unit 111, that is, the calibration process so that the sensor 101 or the distance calculation unit 111 of the vehicle A, 10 can calculate a normal value.

Specifically, for example, internal parameters (focal length, distortion, image center) and external parameters (position and posture) of the sensor 11 are adjusted, and a calibration process (correction process) is executed so that a correct distance can be calculated.

The position analysis unit 114 inputs a signal received by the position information acquisition unit 105 that receives a position identification signal such as a GPS, for example, and analyzes the current location of the vehicle A, 10.

Note that the position analysis processing by the position analysis unit 114 may be executed using information other than the GPS signal or the like. For example, the position information acquisition unit 105 may detect the position identification mark on the road, and the position analysis unit 114 may analyze the self-position on the basis of the position identification mark on the road detected by the position information acquisition unit 105.

The communication unit 103 executes communication processing with other devices, for example, the vehicle B, 20, the infrastructure 30, and the like.

Furthermore, for example, accurate time information is received from a time server such as a network time protocol (NTP) server. This time information is stored in the memory 104 in association with the distance data calculated by the distance calculation unit 111 of the data processing unit 102.

As described above, the memory 104 stores the distance data calculated by the distance calculation unit 111 of the data processing unit 102 in association with the time stamp.

Furthermore, a sensor detection value (for example, a stereo camera-captured image) of the sensor 101 is also stored. The sensor detection value is also recorded in association with the time stamp indicating the sensor detection time.

Furthermore, the memory 104 also stores internal parameters (focal length, distortion, image center) of the sensor 101, external parameters (position and posture), and the like necessary for the correction process (calibration process) of the sensor 101 and the distance calculation unit 111.

As described above, the position information acquisition unit 105 acquires information for recognizing the self-position of the vehicle A, 10, such as GPS signal reception processing or on-road marker detection processing.

The sensor verification device 200 of the vehicle B, 20 has a configuration similar to the sensor verification device 100 of the vehicle A. That is, the sensor 201, the data processing unit 202, the communication unit 203, the memory 204, and the position information acquisition unit 205 have functions similar to those of the core components of the vehicle A, 10 described above. As described above, the data processing unit 202 of the vehicle B, 20 also includes a distance calculation unit, a sensor state determination unit, a calibration execution unit, and a position analysis unit.

A sensor verification device 300 of the infrastructure (road facility) 30 includes a sensor 301, a data processing unit 302, a communication unit 303, and a memory 304. As described above, although not illustrated, the data processing unit 302 of the infrastructure (road facility) 30 includes a distance calculation unit, a sensor state determination unit, and a calibration execution unit.

Unlike a vehicle, the infrastructure (road facility) 30 is a fixed facility that does not move, and thus does not include a position information acquisition unit or a position analysis unit.

However, the position information of the infrastructure (road facility) 30 may be stored in the memory 304.

In addition, the infrastructure (road facility) 30 may be connected to an external management server, and the sensor 301 and the distance calculation unit in the data processing unit 302 may be calibrated periodically under the control of the management server.

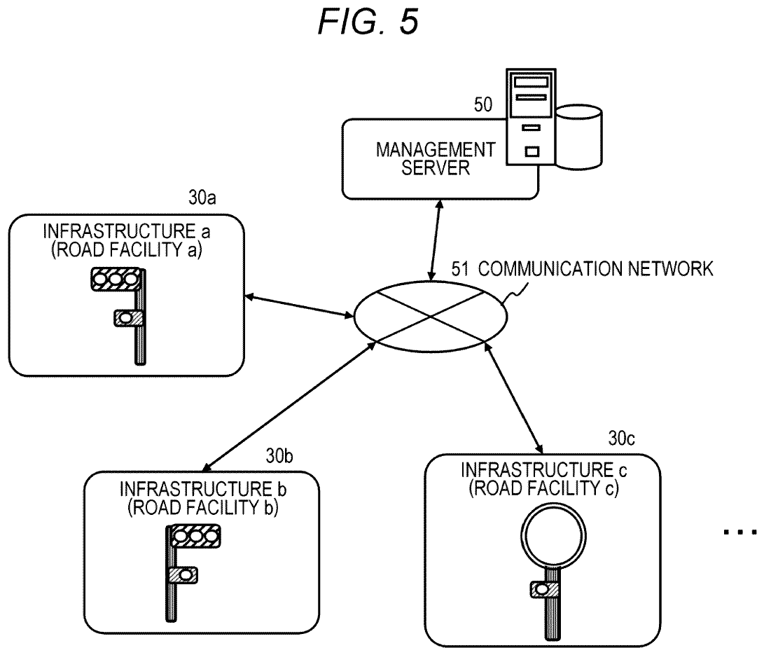

For example, as illustrated in FIG. 5, infrastructures a, 30a, b, 30b, c, 30c, . . . which are a large number of infrastructures grounded on the road are connected to the management server 50 via the communication network 51.

The management server 50 causes each infrastructure to periodically calibrate the sensor 301 and the distance calculation unit in the data processing unit 302.

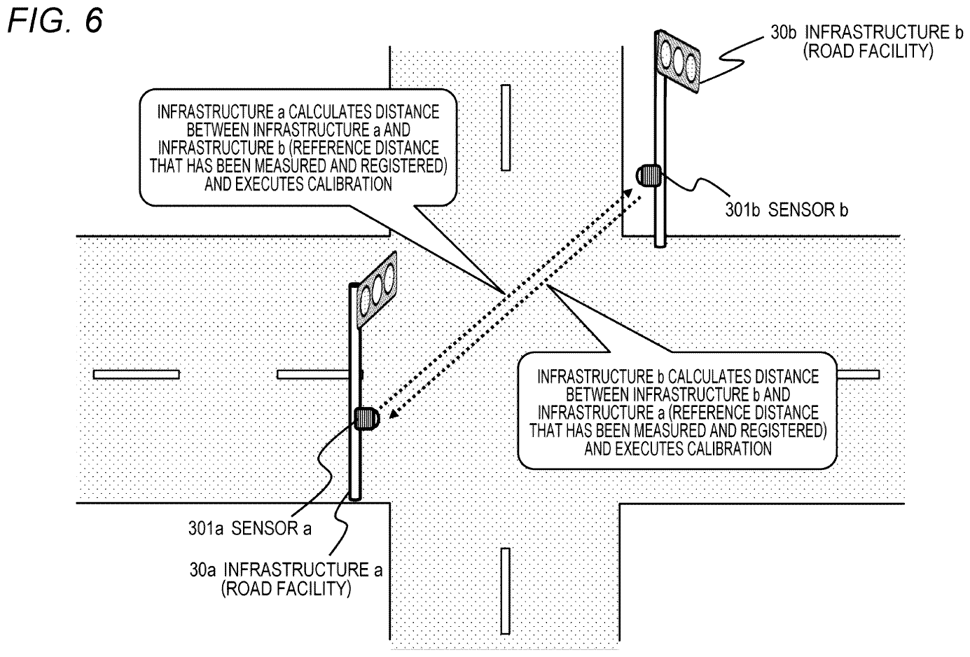

A specific example of the periodic calibration process of the infrastructure will be described with reference to FIG. 6.

FIG. 6 illustrates the infrastructure a, 30a and the infrastructure b, 30b which are two traffic lights connected to the management server 50.

These traffic lights are fixed on the road, and the distance between both infrastructures is a fixed distance. The distance between the infrastructures is measured in advance and registered as reference distance data in the memory of the management server 50 or the memory in the infrastructure.

The management server 50 periodically transmits an execution request of the calibration process to each of the infrastructure a, 30a and the infrastructure b, 30b. For example, an execution request of the calibration process is transmitted every week or every month.

Upon receiving the periodic calibration execution request from the management server 50, the infrastructure a, 30a captures images of the infrastructure b, 30b using the sensor 301a of the infrastructure a, 30a, and calculates the distance between the infrastructure a, 30a and the infrastructure b, 30b on the basis of the captured images. The calculated distance is denoted by Da.

The infrastructure a, 30a further compares the calculated distance Da with the reference distance Ds registered in the memory of the management server 50 or the memory in the infrastructure.

$$Da = Ds$$

When the above formula is satisfied, the sensor 301a and the distance calculation unit in the data processing unit 302 of the infrastructure a, 30a perform accurate distance calculation, and it is confirmed that they are normal.

However,

$$Da = Ds$$

in a case where the above formula is not satisfied, it is confirmed that the sensor 301a and the distance calculation unit in the data processing unit 302 of the infrastructure a, 30a are in a state of not performing accurate distance calculation and are not normal.

In this case, the calibration execution unit in the data processing unit 302 of the infrastructure a, 30a executes the calibration process of the sensor 301a and the distance calculation unit in the data processing unit 302.

Specifically, a process of adjusting an internal parameter (focal length, distortion, image center) and an external parameter (position and posture) of the sensor 301a is executed so that the detection distance of the sensor 301a becomes equal to the reference distance Ds.

With such a process, the infrastructure connected to the management server 50 can constantly maintain a state in which the calibration process is periodically executed and the correct distance can be calculated.

### 3. Sequence of Processing Executed by Sensor Verification Device of Present Disclosure

Next, a sequence of processing executed by the sensor verification device of the present disclosure will be described.

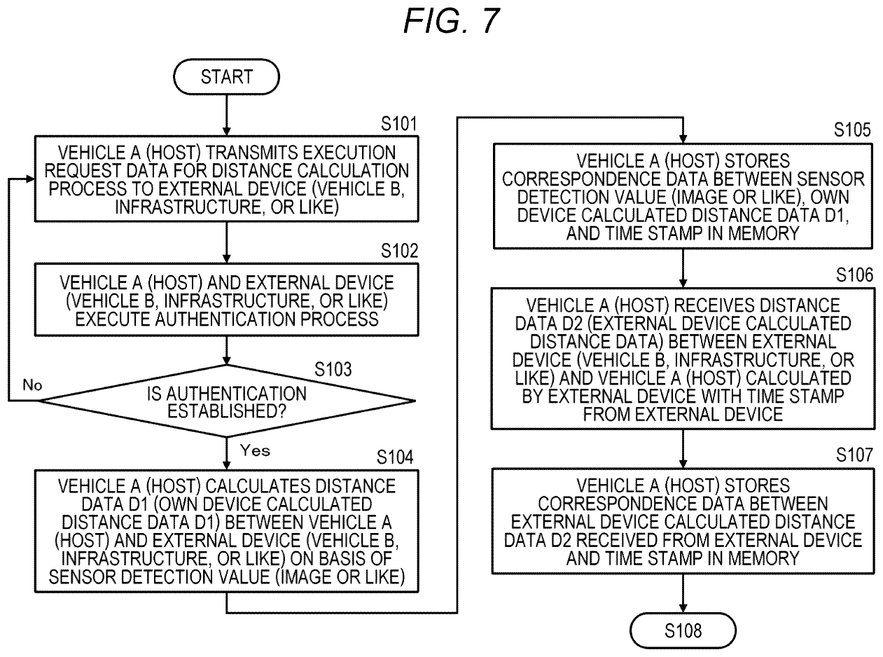

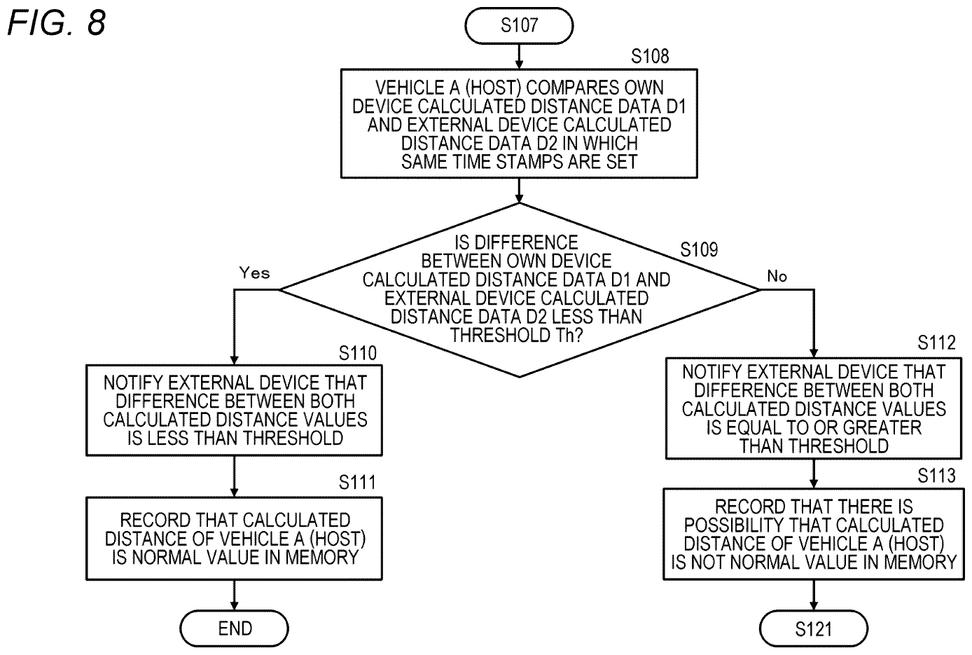

A sequence of processing executed by the sensor verification device of the present disclosure will be described with reference to flowcharts illustrated in FIGS. 7 and 8.

The sequence described with reference to FIGS. 7 and 8 is a sequence of processing executed by the sensor verification device mounted on the vehicle. Here, as an example, the vehicle A, 10 described with reference to FIGS. 1 to 4 is set as a host as a processing execution subject, and a sequence of processing executed by the sensor verification device 100 mounted on the vehicle A (host) 10 will be described.

Note that processing according to the flow described below can be executed according to a program stored in a storage unit of a sensor verification device mounted in a vehicle. For example, it is executed under the control of a data processing unit (control unit) including a CPU or the like having a program execution function.

Hereinafter, processing of each step of the flowcharts illustrated in FIGS. 7 and 8 will be sequentially described.

### (Step S101)

First, in step S101, the sensor verification device mounted on the vehicle A (host) transmits an execution request for a distance calculation process to another vehicle, for example, the vehicle B, or an external device such as an infrastructure (road facility) such as a traffic light.

### (Step S102)

In step S102, the vehicle A (host) and the external device, for example, the vehicle B or the infrastructure, which has received the execution request of the distance calculation process from the vehicle A (host) execute the authentication process in order to confirm the validity of the communication partner.

### (Step S103)

Step S103 is a determination step of determining whether or not the authentication process in step S102 is established.

In a case where the authentication is not established, the communication between the vehicle A (host) and the external device is ended, and the vehicle A (host) returns to step S101 and transmits an execution request of the distance calculation process to another vehicle or a new external device such as an infrastructure (road facility) such as a traffic light.

On the other hand, in a case where the authentication process is established, the process proceeds to step S104.

### (Step S104)

In a case where the vehicle A (host) and the external device, for example, the vehicle B or the infrastructure, which has received the execution request of the distance calculation process from the vehicle A (host) have established the authentication process for confirming the validity of the communication partner, the process of step S104 and subsequent steps is executed.

In this case, the sensor verification device 100 mounted on the vehicle A (host) calculates the distance between the vehicle A and the external device (vehicle B, infrastructure, or the like) in step S104.

That is, the sensor verification device 100 mounted on the vehicle A (host) calculates the distance to the external device (vehicle B, infrastructure, or the like) using the sensor 101.

The sensor 101 is, for example, a stereo camera, and the sensor 101 captures an image of an external device (vehicle B, infrastructure, or the like) and inputs the captured image to the distance calculation unit 111 of the data processing unit 102.

The distance calculation unit 111 inputs detection information of the sensor 101, for example, a plurality of captured images and the like captured from different viewpoints constituting the stereo camera, and calculates the distance to the subject in the camera-captured image.

For example, distance data D1 (own device calculated distance data D1) indicating a distance to the vehicle B, 20 which is an oncoming vehicle illustrated in FIG. 3 and a distance to the infrastructure (road facility) 30 which is a traffic light is calculated.

### (Step S105)

Next, in step S105, the sensor verification device 100 mounted on the vehicle A (host) stores the distance data calculated by the distance calculation unit 111 in step S104, that is, the own device calculated distance data D1 in the memory 104 in association with a time stamp indicating an image capturing time of an image which is a sensor detection value acquired when the distance data D1 is calculated.

Further, image data (stereo image data) that is a sensor detection value used when the distance data D1 is calculated is also stored in the memory.

Note that the image data (stereo image data) may not be stored in the memory. An embodiment related to a configuration in which image data (stereo image data) is not stored in a memory will be described later.

The sensor verification device 100 of the vehicle A, 10 continuously executes the calculation process of the distance between the vehicle A and the external device based on the detection value (stereo camera-captured image) of the sensor 101 of the vehicle A, 10, and records time-series data of the calculated distance in the memory together with the time stamp indicating the distance calculation timing. As described above, the time stamp is assigned using accurate time information received by the vehicle A, 10 from a time server such as a network time protocol (NTP) server.

### (Step S106)

Next, in step S106, the sensor verification device 100 of the vehicle A, 10 receives, from an external device (vehicle B, infrastructure, or the like), distance data D2 (external device calculated distance data D2) indicating the distance between the vehicle A and the external device calculated by the external device together with a time stamp indicating the distance calculation timing.

### (Step S107)

Next, in step S107, the sensor verification device 100 mounted on the vehicle A (host) stores the distance data D2 (external device calculated distance data D2) calculated by the external device and received from the external device in step S106 in the memory 104 together with a time stamp indicating the distance calculation timing.

### (Step S108)

The processing from step S108 is executed by the sensor state determination unit 112 in the data processing unit 102 of the sensor verification device 100 of the vehicle A, 10.

In step S108, the sensor state determination unit 112 in the data processing unit 102 of the sensor verification device 100 of the vehicle A, 10 selectively acquires and compares distance data (own device calculated distance data D1) in which a time stamp at the same timing as a time stamp set in the distance data (external device calculated distance data D2) received from the external device is set, from the time-series data of the own device calculated distance data D1 between the vehicle A and the external device (vehicle B, infrastructure, or the like) continuously calculated by the vehicle A, 10 stored in the memory.

### (Step S109)

Next, in step S109, the sensor verification device 100 of the vehicle A, 10 performs a verification process on the result of the distance data comparison process in step S108.

That is, the following two pieces of distance data set with the same time stamp calculated at the same distance calculation timing are compared.
(Distance data D1) Own device calculated distance data D1 calculated by the vehicle A and stored in a memory in the sensor verification device 100 of the vehicle A,
(Distance data D2) External device calculated distance data D2 calculated by the external device (vehicle B, infrastructure, or the like) and received from the external device,

The sensor verification device 100 of the vehicle A, 10 determines whether or not a difference between the two pieces of distance data, that is, the own device calculated distance data D1 and the external device calculated distance data D2 is less than a predefined threshold (Th).

That is,

$$\vert D 1 - D 2 \vert < Th$$

it is determined whether or not the above determination formula is satisfied.

In a case where it is determined that the above determination formula is satisfied, the process proceeds to step S110.

On the other hand, in a case where it is determined that the above determination formula is not satisfied, the process proceeds to step S112.

### (Step S110)

In step S109,

$$\vert D 1 - D 2 \vert < Th$$

in a case where it is determined that the above determination formula is satisfied, that is, in a case where it is determined that the difference between the own device calculated distance data D1 and the external device calculated distance data D2 is less than the predefined threshold (Th), the sensor verification device 100 of the vehicle A, 10 executes the processing of steps S110 to S111.

$$\vert D 1 - D 2 \vert < Th$$

In a case where it is determined that the above determination formula is satisfied, the sensor verification device 100 of the vehicle A, 10 determines that the own device calculated distance data D1 calculated by the vehicle A and stored in the memory in the sensor verification device 100 of the vehicle A is correct distance data, and the sensor 101 of the sensor verification device 100 and the distance calculation unit 111 of the data processing unit 102 of the vehicle A are normally operating. In this case, it is determined that a calibration process as a correction process of the sensor 101, the distance calculation parameter, and the like is unnecessary.

In this case, the sensor verification device 100 of the vehicle A, 10 first notifies the external device that has transmitted the external device calculated distance data D2 in step S110 that the difference between the calculated distance data (D1, D2) of both, that is, the vehicle A (host) and the external device is less than the threshold.

By receiving this notification from the vehicle A (host), the external device can confirm that there is a high possibility that the distance calculation in the external device (vehicle B, infrastructure, or the like) is normally performed.

### (Step S111)

Furthermore, in step S111, the sensor verification device 100 of the vehicle A, 10 records, in the memory 104, sensor state information indicating that the sensor 101 and the distance calculation unit 111 of the data processing unit 102 of the vehicle A are executing accurate distance calculation and are operating normally.

### (Step S112)

On the other hand, in step S109,

$$\vert D 1 - D 2 \vert < Th$$

in a case where it is determined that the above determination formula is not satisfied, that is, in a case where it is determined that the difference between the own device calculated distance data D1 and the external device calculated distance data D2 is not less than the predefined threshold (Th), the sensor verification device 100 of the vehicle A, 10 executes the processing of steps S112 to S113.

In this case, the sensor verification device 100 of the vehicle A, 10 determines that the own device calculated distance data D1 calculated by the vehicle A and stored in the memory in the sensor verification device 100 of the vehicle A is distance data that may be incorrect, and the sensor 101 of the sensor verification device 100 and the distance calculation unit 111 of the data processing unit 102 of the vehicle A may not operate normally.

In this case, it is determined that there is a possibility that a calibration process as a correction process of the sensor 101, the distance calculation parameter, and the like is necessary.

In this case, the sensor verification device 100 of the vehicle A, 10 first notifies the external device that has transmitted the external device calculated distance data D2 in step S112 that the difference between the calculated distance data (D1, D2) of both, that is, the vehicle A (host) and the external device is equal to or greater than the threshold.

By receiving this notification from the vehicle A (host), the external device can confirm that there is a possibility that the distance calculation in the external device (vehicle B, infrastructure, or the like) is not normally performed.

### (Step S113)

Furthermore, in step S113, the sensor verification device 100 of the vehicle A, 10 records, in the memory 104, sensor state information indicating that the sensor 101 and the distance calculation unit 111 of the data processing unit 102 of the vehicle A may not have executed accurate distance calculation.

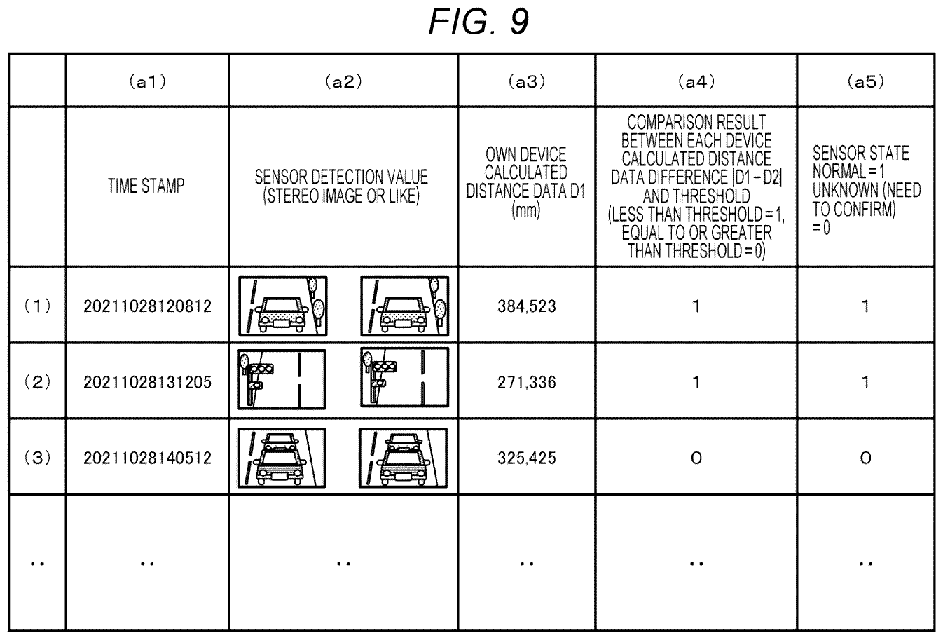

An example of data recorded in the memory 104 by the sensor verification device 100 of the vehicle A, 10 will be described with reference to FIG. 9.

As illustrated in FIG. 9, the following data is recorded in the memory 104.
(a1) Time stamp
(a2) Sensor detection value (stereo image or the like)
(a3) Own device calculated distance data D1
(a4) Comparison result between each device calculated distance data difference D1-D2 and threshold Th
(a5) Sensor state determination result (normal=1, unknown=0)

“(a1) Time stamp” is time information indicating the acquisition timing of the sensor detection value (stereo image or the like) by the sensor 101 when the own device calculated distance data D1 is calculated.

“(a2) Sensor detection value (stereo image or the like)” is a sensor detection value (stereo image or the like) by the sensor 101.

Note that the vehicle A, 10 continuously acquires sensor detection values (stereo images and the like) by the sensor 101 and stores the sensor detection values in the memory 104. However, sensor detection values (stereo images and the like) other than the sensor detection values (stereo images and the like) for which the distance comparison process with the external device calculated distance data D2 has been performed become unnecessary thereafter, and thus are deleted from the memory 104.

FIG. 9 illustrates an example in which only the sensor detection values (stereo image or the like) subjected to the distance comparison process with the external device calculated distance data D2 are left as record data.

Furthermore, the example illustrated in the drawing is an example of a sensor detection value in a case where the sensor 101 is a stereo camera that captures a stereo image. For example, in a case where the sensor 101 is another sensor, for example, a distance measuring sensor such as LiDAR, TOF sensor, or millimeter wave radar, measured distance data by these sensors is stored.

Furthermore, in a case where the sensor 101 is a monocular camera, one captured image by the monocular camera is recorded.

“(a3) Own device calculated distance data D1” is distance data calculated by the distance calculation unit 111 of the data processing unit 102 on the basis of the sensor detection value (stereo image or the like) acquired by the sensor 101 of the vehicle A, 10. It is distance data between the vehicle A, 10 and an external device (vehicle B, infrastructure, or the like). “(a4) Comparison result between each device calculated distance data difference D1-D2 and threshold Th” stores a result of the distance comparison process executed by the sensor state determination unit 112 of the data processing unit 102 of the sensor verification device 100 of the vehicle A, 10.

The difference D1-D2 between the own device calculated distance data D1 calculated by the vehicle A and stored in the memory in the sensor verification device 100 of the vehicle A and the external device calculated distance data D2 calculated by the external device calculated (the vehicle B, the infrastructure, or the like) and received from the external device with the threshold Th are compared, and

$$\vert D 1 - D 2 \vert < Th$$

[1] is recorded in a case where the above determination formula is satisfied, and [0] is recorded in a case where the above determination formula is not satisfied.

“(a5) Sensor state determination result (normal=1, unknown=0)” stores the determination result of the sensor state according to the value of “(a4) Comparison result between each device calculated distance data difference |D1-D2| and threshold Th”.

In a case where the difference between the calculated distance points of the own device and the external device is less than the threshold, that is,

$$\vert D 1 - D 2 \vert < Th$$

in a case where the above determination formula is satisfied, it is determined that the distance measurement by the sensor is correctly executed, and the identifier [1] indicating that the sensor state is normal is recorded.

On the other hand, in a case where the above determination formula is not satisfied, it is determined that there is a possibility that the distance measurement by the sensor is not correctly executed, and the identifier [0] indicating that whether or not the sensor state is normal is unknown is recorded.

Note that, in the memory 104 of the sensor verification device 100 of the vehicle A, 10, the external device calculated distance data D2 received from an external device (vehicle B, infrastructure, or the like) and the like are also recorded.

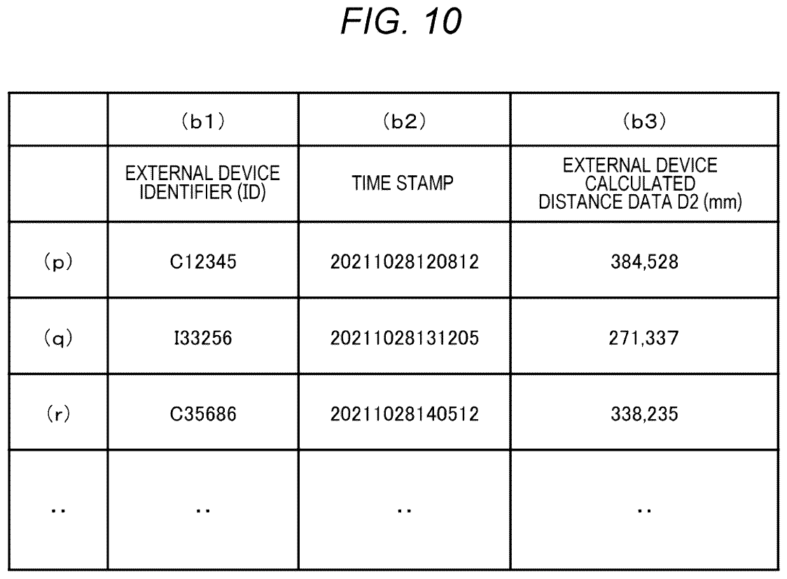

An example of reception data from an external device recorded in the memory 104 will be described with reference to FIG. 10.

As illustrated in FIG. 10, the following data is recorded in the memory 104 of the sensor verification device 100 of the vehicle A (host).
(b1) External device identifier (ID)
(b2) Time stamp
(b3) External device calculated distance data D2

“(b1) External device identifier (ID)” is an identifier of an external device (vehicle B, infrastructure, or the like) that has communicated with the vehicle A (host) and has transmitted the external device calculated distance data D2 to the vehicle A (host).

The external device identifier (ID) is received by the vehicle A (host) from an external device (vehicle B, infrastructure, or the like) in the authentication process of step S102 described above with reference to the flow of FIG. 7.

The external device identifier (ID) indicates, for example, whether the external device is an infrastructure or a vehicle, and is configured as data that can identify the type of each infrastructure, vehicle, and the like.

In the example of the identifier (ID) illustrated in the drawing, C represents a vehicle, and I represents an infrastructure.

“(b2) Time stamp” is time information indicating the acquisition timing of the sensor detection value (stereo image or the like) by the sensor when the external device (vehicle B, infrastructure, or the like) calculates the external device calculated distance data D2.

“(b3) External device calculated distance data D2” is distance data between the external device (vehicle B, infrastructure, or the like) and the vehicle A (host) calculated by the external device (vehicle B, infrastructure, or the like).

As described above, the sensor verification device 100 of the vehicle A, 10 stores the data related to the own device described with reference to FIG. 9 and the data received from the external device (vehicle B, infrastructure, or the like) described with reference to FIG. 10 in the memory 104.

The sensor verification device 100 of the vehicle A, 10 executes processing using the data stored in the memory 104 in a case of performing a calibration process of the sensor 101 and the like in the sensor verification device 100.

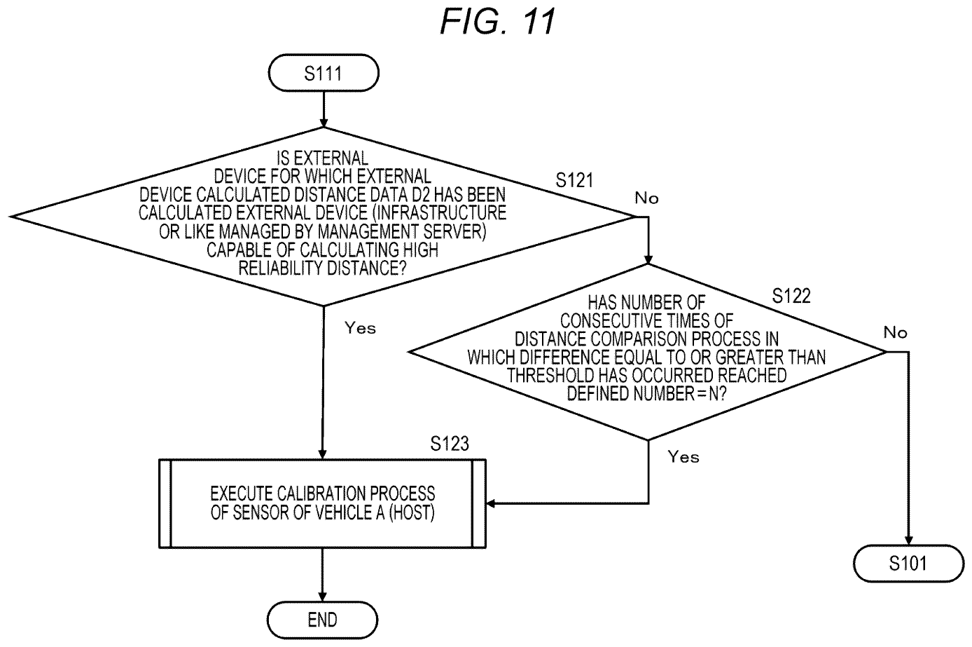

The sequence of the calibration process executed by the sensor verification device 100 of the vehicle A, 10 will be described with reference to the flowchart in FIG. 11 and subsequent drawings.

The flowchart illustrated in FIG. 11 is a flow illustrating processing executed after the processing of steps S112 to S113 of the flowchart illustrated in FIG. 8 described above.

As described above, as a result of performing the comparison process between the difference between the own device calculated distance data D1 and the external device calculated distance data D2 and the threshold Th in step S109 of the flow illustrated in FIG. 8,

$$\vert D 1 - D 2 \vert < Th$$

the processing of steps S112 to S113 of the flowchart illustrated in FIG. 8 is performed in a case where it is determined that the determination formula is not satisfied.

That is, in a case where it is determined in step S109 that the difference between the own device calculated distance data D1 and the external device calculated distance data D2 is not less than the predefined threshold (Th), the sensor verification device 100 of the vehicle A, 10 notifies the external device that has transmitted the external device calculated distance data D2 of that the difference between both, that is, the calculated distance data (D1, D2) of the vehicle A (host) and the external device is equal to or greater than the threshold in step S112.

Furthermore, in step S113, sensor state information is recorded in the memory 104 indicating that there is a possibility that accurate distance calculation has not been executed by the sensor 101 and the distance calculation unit 111 of the data processing unit 102 of the vehicle A.

The record data in step S113 is, for example, the following data illustrated in FIG. 9.

(a4) Comparison result between each device calculated distance data difference D1-D2 and threshold Th

(a5) Sensor state determination result (normal=1, unknown=0)

As described above, in a case where it is determined in step S109 that the difference between the own device calculated distance data D1 and the external device calculated distance data D2 is not less than the predefined threshold (Th), the processing of notifying the external device (vehicle B, infrastructure, or the like) is performed in step S112, the data is recorded in the memory in step S113, and then the processing subsequent to step S121 of the flowchart illustrated in FIG. 11 is performed.

Hereinafter, details of processing of each step of the flowchart illustrated in FIG. 11 will be described.

### (Step S121)

In step S121, the sensor verification device 100 of the vehicle A determines whether or not the external device for which the external device calculated distance data D2 has been calculated is an external device (an infrastructure or the like managed by the management server) capable of calculating a high reliability distance.

Note that the processing in step S121 is executed by the sensor state determination unit 112 in the data processing unit 102 of the sensor verification device 100 of the vehicle A, 10.

As described above with reference to FIGS. 5 and 6, for example, an infrastructure such as a traffic light may be connected to an external management server, and calibration as maintenance of a sensor and a distance calculation unit in the infrastructure may be periodically performed under the control of the management server.

By such a periodic calibration process, the infrastructure connected to the management server can always maintain a state in which the correct distance can be calculated.

In step S121 of the flow illustrated in FIG. 11, a process of determining whether or not the external device requested to calculate the distance by the vehicle A is an external device capable of performing such periodic maintenance and accurate distance calculation is executed.

This determination process is performed, for example, on the basis of an external device identifier (ID) received from an external device.

As described above with reference to FIG. 10, the memory 104 of the sensor verification device 100 of the vehicle A (host) stores “(b1) External device identifier (ID)”.

“(b1) External device identifier (ID)” is an identifier of an external device (vehicle B, infrastructure, or the like) that has communicated with the vehicle A (host) and transmitted the external device calculated distance data D2 to the vehicle A (host).

The external device identifier (ID) is received by the vehicle A (host) from the external device (vehicle B, infrastructure, or the like) and recorded in the memory 104 in the authentication process of step S102 described above with reference to the flow of FIG. 7.

The sensor verification device 100 of the vehicle A (host) refers to the external device identifier (ID) received from the external device and recorded in the memory 104 to determine whether or not the external device is an external layer capable of calculating reliable distance data. Specifically, for example, it is discriminated whether the external device is an infrastructure or a vehicle other than the infrastructure.

As described above, the external device identifier (ID) indicates, for example, whether the external device is an infrastructure or a vehicle, and is configured as data that can identify the type of each infrastructure, vehicle, and the like. In the example of the identifier (ID) illustrated in FIG. 10, C represents a vehicle, and I represents an infrastructure.

In a case where it is determined in step S121 that the external device for which the external device calculated distance data D2 has been calculated is an external device (an infrastructure or the like managed by the management server) capable of calculating a high reliability distance, the process proceeds to step S123.

On the other hand, in a case where it is determined in step S121 that the external device for which the external device calculated distance data D2 has been calculated is not an external device (an infrastructure or the like managed by the management server) capable of calculating a high reliability distance, the process proceeds to step S122.

Note that step S123 is a step of executing calibration of a sensor or the like of the vehicle A.

In a case where the external device for which the external device calculated distance data D2 has been calculated is an external device capable of calculating a high reliability distance, the external device calculated distance data D2 is estimated to be correct distance data.

Furthermore, in step S109 of the flow of FIG. 8 described above, the own device calculated distance data D1 for which it is determined that the difference from the external device calculated distance data D2 is equal to or greater than the threshold Th is determined to be erroneous distance data.

In a case where these determinations have been made, a calibration process such as a parameter correction process for enabling the sensor of the vehicle A to calculate a correct distance is executed in step S123.

### (Step S122)

Step S122 is executed in a case where it is determined in step S121 that the external device for which the external device calculated distance data D2 has been calculated is not an external device (infrastructure or the like managed by the management server) capable of calculating a high reliability distance.

In this case, the sensor verification device 100 of the vehicle A determines whether or not a predefined calibration execution condition is satisfied in step S122.

Note that the processing in step S122 is executed by the sensor state determination unit 112 in the data processing unit 102 of the sensor verification device 100 of the vehicle A, 10.

Specifically, the predefined calibration execution condition is the following condition.

(Condition) The number of consecutive times of the distance comparison process in which the difference equal to or greater than the threshold has occurred has reached a defined number=N.

In a case where it is determined in step S122 that the above (condition) is satisfied, the process proceeds to step S123 and the calibration process is executed.

On the other hand, in a case where it is determined in step S122 that the above (condition) is not satisfied, the processing returns to step S101 to execute communication with a new external device and execute the comparison process of the distance calculated between the own device and the new external device.

The determination process in step S122 is a process of performing the following determination.

That is, it is a process where the vehicle A executes the processing according to the flow illustrated in FIGS. 7 to 8 on different external devices, and in the distance comparison process in step S109 illustrated in FIG. 8, that is, the comparison process between the threshold Th and the difference |D1-D2 | between the own device calculated distance data D1 calculated by the vehicle A and the external device calculated distance data D2 calculated by the external device (the vehicle B, the infrastructure, or the like),

$$\vert D 1 - D 2 \vert < Th$$

whether or not the number of times the above determination formula is not satisfied has continuously reached a defined number of times N is determined.

In a case where the number of consecutive times of the distance comparison process in which the difference equal to or greater than the threshold is generated reaches the defined number=N, it is determined that the calculated distance on the own device, that is, the vehicle A side, that is, the own device calculated distance data D1 is incorrect, and the process proceeds to step S123 to execute calibration of the sensor 101 of the own device (vehicle A).

On the other hand, in a case where the number of consecutive times of the distance comparison process in which the difference equal to or greater than the threshold has occurred does not reach the defined number=N times, it is difficult to discriminate whether the own device calculated distance data D1 is an incorrect value or the external device calculated distance data D2 that is the calculated distance of the external device is incorrect data. Therefore, in this case, the process returns to step S101, communication with a new external device is executed, and the comparison process of the distance calculated between the own device and the new external device is executed.

### (Step S123)

The processing in step S123 is processing executed in a case where any of the following two cases is applicable.

(Case 1) A case where it is determined in step S121 that the external device for which the external device calculated distance data D2 has been calculated is an external device (an infrastructure or the like managed by a management server) capable of calculating a high reliability distance.

(Case 2) A case where the number of consecutive times of the distance comparison process in which the difference equal to or greater than the threshold has occurred has reached a defined number=N in step S122.

In a case where any of these cases occurs, the sensor verification device 100 of the vehicle A determines that the calculated distance on the own device, that is, the vehicle A side, that is, the own device calculated distance data D1 is incorrect, and proceeds to step S123 to execute calibration of the sensor 101 of the own device (vehicle A).

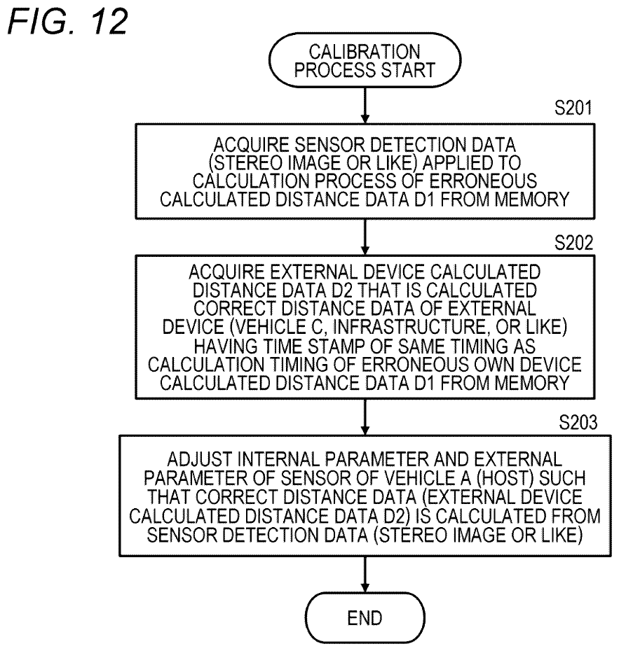

A detailed sequence of the calibration process in step S123 will be described with reference to a flowchart illustrated in FIG. 12.

The flowchart illustrated in FIG. 12 is processing executed by the calibration execution unit 113 of the data processing unit 102 of the sensor verification device 100 of the vehicle A.

Hereinafter, processing of each step of the flow illustrated in FIG. 12 will be sequentially described.

### (Step S201)

The calibration execution unit 113 of the data processing unit 102 of the sensor verification device 100 of the vehicle A first executes the following processing in step S201.

The sensor detection value (stereo image or the like) applied to the calculation process of the own device calculated distance data D1 determined as erroneous calculated distance data is acquired from the memory 104.

A specific processing example will be described with reference to the memory-stored data described above with reference to FIGS. 9 and 10.

The memory 104 stores, for example, data illustrated in FIG. 9. Among these pieces of data, the own device calculated distance data D1 determined as erroneous calculated distance data is set as the data of the entry (3) illustrated in FIG. 9.

The value of the own device calculated distance data D1 of the entry (3) illustrated in FIG. 9 is

$$D 1 = 352 , 425 ( mm ) .$$

It is assumed that the own device calculated distance data D1 is distance data determined to be erroneous distance data.

In step S201, the own device calculated distance data D1 determined as the erroneous distance data,

$$D 1 = 352 , 425 ( mm ) .$$

the sensor detection value (stereo image or the like) applied to the calculation process of this distance data is acquired from the memory 104.

That is, in the entry (3) in the memory-stored data illustrated in FIG. 9,
two images indicated in (a2) sensor detection value (stereo image) are acquired.

These two images are two images obtained by capturing an external device (vehicle) from different viewpoint positions.

A vehicle as a subject included in this image is a vehicle that has calculated the external device calculated distance data D2, and the vehicle A stores the external device calculated distance data D2 in the memory 104 together with a time stamp.

That is, it is the memory-stored data described above with reference to FIG. 10.

### (Step S202)

Next, the calibration execution unit 113 of the data processing unit 102 of the sensor verification device 100 of the vehicle A executes the following processing in step S202.

External device calculated distance data D2 estimated to be correct distance data calculated by an external device (vehicle B, infrastructure, or the like) having a time stamp at the same timing as the erroneous calculation timing of the own device calculated distance data D1 is acquired from the memory.

As described above with reference to FIG. 10, the memory 104 stores reception data from an external device. That is, the memory 104 stores the following data received from the external device.
(b1) External device identifier (ID)
(b2) Time stamp
(b3) External device calculated distance data D2

In step S202, the calibration execution unit 113 selects, from the plurality of entries (p), (q), (r), . . . illustrated in FIG. 10, an entry in which a time stamp having the same time as the time stamp indicating the capturing timing of the sensor detection value (stereo image or the like) selected in the previous step S201 is set.

The time stamp indicating the capturing timing of the sensor detection value (stereo image or the like) selected in the previous step S201 is the time stamp of the entry (3) in the memory-stored data illustrated in FIG. 9, and the value is

$$time stamp = 2.0211028140512 \times {10}^{13}$$

The time stamp is time information indicating the capturing timing of the sensor detection value (stereo image or the like) of the entry (3) in the memory-stored data illustrated in FIG. 9,
Oct. 28, 2021, 14:05:12
and it is data indicating that the sensor detection value (stereo image or the like) of the entry (3) is captured at this time.

In step S202, an entry in which a time stamp having the same time information as the time stamp is set is selected from the plurality of entries (p), (q), (r) . . . illustrated in FIG. 10.

In the entries (p) to (r) illustrated in FIG. 10,
time stamp of the entry (3) illustrated in FIG. 9=20211028140512
an entry in which the same time stamp as this time stamp is set is the entry (r).

In step S202, the calibration execution unit 113 of the data processing unit 102 of the sensor verification device 100 of the vehicle A acquires the external device calculated distance data D2 of the entry (r) in which the same time stamp as the time stamp=20211028140512 of the entry (3) illustrated in FIG. 9 is set from the memory-stored data illustrated in FIG. 10, that is, the reception data from the external device.

The external device calculated distance data D2 in the entry (r) illustrated in FIG. 10 is distance data calculated by the external device at exactly the same timing as the timing at which the own device calculated distance data D1 in the entry (3) illustrated in FIG. 9 is calculated, and is distance data estimated to be correct distance data.

### (Step S203)

Next, the calibration execution unit 113 of the data processing unit 102 of the sensor verification device 100 of the vehicle A executes the following processing in step S203.

Internal parameters and external parameters of the sensor 101 of the vehicle A (host) are adjusted such that correct distance data (external device calculated distance data D2) acquired from the memory 104 in step S202 is calculated from the sensor detection value (stereo image or the like) acquired from the memory 104 in step S201.

That is, the internal parameters and the external parameters of the sensor 101 of the vehicle A (host) are adjusted such that the external device calculated distance data D2 of the entry (r) illustrated in FIG. 10 estimated to be correct distance data is calculated from the two images which are the sensor detection values (stereo images) of the entry (3) in the memory-stored data illustrated in FIG. 9.

Specifically, for example, internal parameters (focal length, distortion, image center) and external parameters (position and posture) of the sensor 101 are adjusted, and a calibration process (correction process) is executed so that a correct distance can be calculated.

As described above, the sensor verification device mounted on the vehicle of the present disclosure executes communication with an external device such as a vehicle of the value or an infrastructure such as a traffic light while traveling on a road, and calculates the same vehicle-to-vehicle distance or the distance between the vehicle and the infrastructure at the same timing, and these two calculations compare the distances to verify whether or not the correct distance calculation has been performed.

Furthermore, in a case where it is determined that the correct distance calculation has not been performed, a calibration process of a sensor or the like is executed so that the correct distance calculation is possible.

The vehicle can execute a distance calculation process with other vehicles and infrastructures at various timings while traveling on the road, and can frequently perform a calibration process according to the distance calculation result.

With these processes, it is possible to prevent a decrease in distance calculation accuracy by the sensor, and it is possible to realize highly safe automated driving and driving support.

### 4. Communication Sequences Between Vehicles and Between Vehicle and Infrastructure

Next, a communication sequence between vehicles and between a vehicle and an infrastructure executed when the processing of the present disclosure is performed will be described.

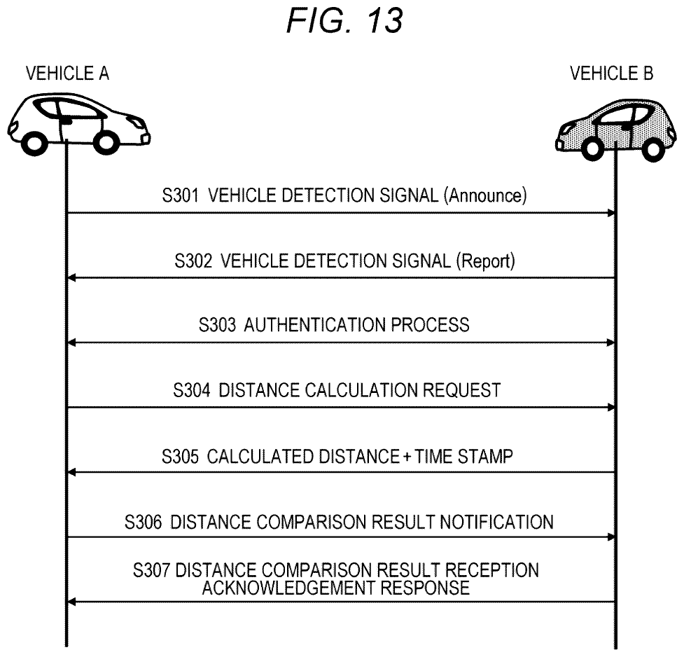

Communication sequences in the following three cases will be sequentially described with reference to FIGS. 13 to 15.
(Case 1) Communication sequence between vehicle A and vehicle B
(Case 2) Communication sequence example 1 between vehicle A and infrastructure
(Case 3) Communication sequence example 2 between vehicle A and infrastructure

### (Case 1) Communication Sequence Between Vehicle a and Vehicle B

First, as (Case 1), a communication sequence between the vehicles A and B in a case where communication is performed between the vehicle A and the vehicle B, the distance between the vehicles A and B is calculated at the same timing in both the vehicle A and the vehicle B, and the vehicle A performs processing of comparing these two calculated distances will be described with reference to a sequence diagram illustrated in FIG. 13.

In FIG. 13, the vehicle A is illustrated on the left side, and the vehicle B is illustrated on the right side.

Communication processing between vehicles is executed according to the sequence of steps S301 to S307 illustrated in FIG. 13.

Hereinafter, the processing of each step is described in order.

### (Step S301)

First, in step S301, the vehicle A transmits a vehicle detection signal (Announce).

The vehicle detection signal (Announce) is an announcement signal for detecting a vehicle that executes distance calculation, and is not a transmission signal for a specific vehicle. A signal directed to an unspecified vehicle, for example, a broadcast signal, is transmitted.

### (Step S302)

Upon receiving the vehicle detection signal (Announce) transmitted by the vehicle A, the vehicle B transmits a response (vehicle detection signal (Report)), which is a response signal indicating that the vehicle detection signal (Announce) of the vehicle A has been received, to the vehicle A in step S302.

### (Step S303)

Next, upon receiving the response signal (vehicle detection signal (Report)) from the vehicle B, the vehicle A starts an authentication process between the vehicle A and the vehicle B in step S303.

In this authentication process, the vehicle A and the vehicle B perform, for example, an ID exchange process as a confirmation process of confirming that the vehicle A and the vehicle B performing communication are mutually reliable vehicles, a sharing process of key data and the like applied to an encryption process of communication data, and the like.

When the authentication is established, the process proceeds to the next step.

In a case where the authentication is not established, the subsequent processing is not executed.

### (Step S304)

When the authentication process is established in step S303, the vehicle A then transmits a distance calculation request to the vehicle B in step S304. That is, it is requested to execute the calculation process of the distance between the vehicle A and the vehicle B.

### (Step S305)

Upon receiving the distance calculation request transmitted by the vehicle A, the vehicle B executes a distance calculation process between the vehicles A and B in step S305, and transmits the calculated vehicle-to-vehicle distance data and a time stamp indicating the distance calculation time to the vehicle A.

### (Step S306)

Upon receiving the vehicle-to-vehicle distance data (external device calculated distance data D2) and the time stamp indicating the distance calculation time from the vehicle B, the vehicle A selects the own device calculated distance data D1 in which the same time stamp as the time stamp received from the vehicle B is set from the distance data between the vehicles A and B calculated on the vehicle A side (own device calculated distance data D1), and compares the selected data with the external device calculated distance data D2 received from the vehicle B.

In step S306, the vehicle A transmits the comparison result to the vehicle B.

The notification processing of the distance comparison result information from the vehicle A to the vehicle B corresponds to the processing of step S110 and the processing of step S112 of the flowchart described above with reference to FIG. 8.

That is, in step S109 of the flowchart described with reference to FIG. 8, notification processing of different distance comparison result information is executed according to whether or not the difference between the own device calculated distance data D1 and the external device calculated distance data D2 is less than the defined threshold.

In a case where the difference between the own device calculated distance data D1 calculated by the vehicle A and the external device calculated distance data D2 calculated by the vehicle B is less than the defined threshold, the processing of step S110 of the flowchart described above with reference to FIG. 8 is executed.

In this case, the vehicle A notifies the vehicle B that has transmitted the external device calculated distance data D2 that the difference between the calculated distance data (D1, D2) of both, that is, both the vehicles A and B, is less than the threshold.

By receiving this notification from the vehicle A, the vehicle B can confirm that there is a high possibility that the distance calculation is normally performed in the vehicle B.

On the other hand, in a case where the difference between the own device calculated distance data D1 calculated by the vehicle A and the external device calculated distance data D2 calculated by the vehicle B is not less than the defined threshold, the processing of step S112 of the flowchart described above with reference to FIG. 8 is executed.

In this case, the vehicle A notifies the vehicle B that has transmitted the external device calculated distance data D2 that the difference between the calculated distance data (D1, D2) of both, that is, both the vehicles A and B, is not less than the threshold.

By receiving this notification from the vehicle A, the vehicle B can confirm that there is a possibility that the distance calculation has not been normally performed in the vehicle B.

### (Step S307)

The vehicle B that has received notification of the own device calculated distance data D1, the external device calculated distance data D2, and the distance comparison result information from the vehicle A transmits, to the vehicle A, an acknowledgement response indicating that the distance comparison result information has been received.

As described above, the communication processing in steps S301 to S307 is executed between the vehicles A and B.

After these communication processes, the vehicle A performs a calibration process for a sensor mounted on the vehicle A as necessary.

That is, as described above with reference to the flowchart illustrated in FIG. 11, for example, in step S122 of the flow illustrated in FIG. 11, in a case where it is determined that the number of consecutive times of the distance comparison process in which the difference equal to or greater than the threshold has occurred has reached the defined number=N, the calibration process for the sensor mounted on the vehicle A is performed.

The sensor calibration process is executed according to, for example, the sequence illustrated in the flowchart illustrated in FIG. 12 described above.

### (Case 2) Communication Sequence Example 1 Between Vehicle a and Infrastructure

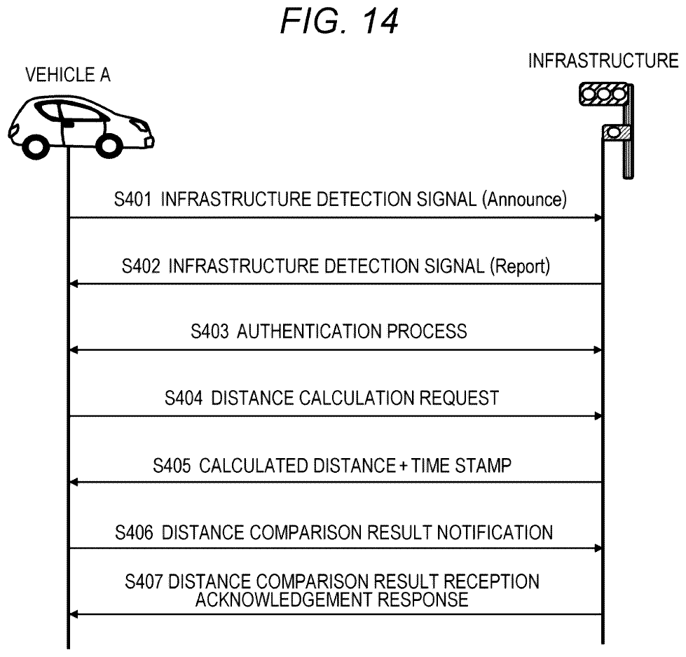

Next, as (Case 2), an example 1 of a communication sequence between the vehicle A and the infrastructure will be described with reference to a sequence diagram illustrated in FIG. 14 in a case where communication is performed between the vehicle A and the infrastructure which is a road facility such as a traffic light, a distance between the vehicle A and the infrastructure is calculated at the same timing in both the vehicle A and the infrastructure, and the vehicle A performs processing of comparing these two calculated distances.

In FIG. 14, the vehicle A is illustrated on the left side, and the infrastructure is illustrated on the right side.

Communication processing between the vehicle and the infrastructure is executed according to the sequence of steps S401 to S407 illustrated in FIG. 14.

Hereinafter, the processing of each step is described in order.

### (Step S401)

First, in step S401, the vehicle A transmits an infrastructure detection signal (Announce).

As the infrastructure detection signal (Announce), a signal similar to the vehicle detection signal (Announce) in the communication sequence between the vehicles A and B described above with reference to FIG. 13 can be used. It is an announcement signal for detecting an infrastructure that executes distance calculation, and is not a transmission signal for a specific infrastructure or vehicle. A signal for an unspecified infrastructure or vehicle, for example, a broadcast signal, is transmitted.

### (Step S402)

Upon receiving the infrastructure detection signal (Announce) transmitted by the vehicle A, the infrastructure transmits a response (infrastructure detection signal (Report)), which is a response signal indicating that the infrastructure detection signal (Announce) of the vehicle A has been received, to the vehicle A in step S402.

### (Step S403)

Next, upon receiving the response signal (infrastructure detection signal (Report)) from the infrastructure, the vehicle A starts the authentication process between the vehicle A and the infrastructure in step S403.

In this authentication process, the vehicle A and the infrastructure perform, for example, an ID exchange process as a confirmation process that the vehicle A and the infrastructure performing communication are a mutually reliable vehicle and infrastructure, a sharing process of key data and the like applied to an encryption process of communication data, and the like.

When the authentication is established, the process proceeds to the next step.

In a case where the authentication is not established, the subsequent processing is not executed.

### (Step S404)

When the authentication process is established in step S403, the vehicle A then transmits a distance calculation request to the infrastructure in step S404. That is, it is requested to execute the calculation process of the distance between the vehicle A and the infrastructure.

### (Step S405)

In step S405, the infrastructure that has received the distance calculation request transmitted by the vehicle A executes a distance calculation process between the vehicle A and the infrastructure, and transmits the calculated vehicle-infrastructure distance data and a time stamp indicating the distance calculation time to the vehicle A.

### (Step S406)

Upon receiving the vehicle-infrastructure distance data (external device calculated distance data D2) and the time stamp indicating the distance calculation time from the infrastructure, the vehicle A selects the own device calculated distance data D1 in which the same time stamp as the time stamp received from the infrastructure is set from the distance data (own device calculated distance data D1) between the vehicle A and the infrastructure already calculated on the vehicle A side, and compares the selected data with the external device calculated distance data D2 received from the infrastructure.

In step S406, the vehicle A transmits the comparison result to the infrastructure.

The notification processing of the distance comparison result information from the vehicle A to the infrastructure corresponds to the processing of step S110 and the processing of step S112 of the flowchart described above with reference to FIG. 8.

That is, in step S109 of the flowchart described with reference to FIG. 8, notification processing of different distance comparison result information is executed according to whether or not the difference between the own device calculated distance data D1 and the external device calculated distance data D2 is less than the defined threshold.

In a case where the difference between the own device calculated distance data D1 calculated by the vehicle A and the external device calculated distance data D2 calculated by the infrastructure is less than the defined threshold, the processing of step S110 of the flowchart described above with reference to FIG. 8 is executed.

In this case, the vehicle A notifies the infrastructure that has transmitted the external device calculated distance data D2 that the difference between the calculated distance data (D1, D2) of both, that is, the vehicle A and the infrastructure is less than the threshold.

On the other hand, in a case where the difference between the own device calculated distance data D1 calculated by the vehicle A and the external device calculated distance data D2 calculated by the infrastructure is not less than the defined threshold, the processing in step S112 of the flowchart described above with reference to FIG. 8 is executed.

In this case, the vehicle A notifies the infrastructure that has transmitted the external device calculated distance data D2 that the difference between the calculated distance data (D1, D2) of both, that is, the vehicle A and the infrastructure is not less than the threshold.

### (Step S407)

Upon receiving the notification of the own device calculated distance data D1, the external device calculated distance data D2, and the distance comparison result information from the vehicle A, the infrastructure transmits, to the vehicle A, an acknowledgement response indicating that the distance comparison result information has been received.

As described above, the communication processing in steps S401 to S407 is executed between the vehicle A and the infrastructure.

After these communication processes, the vehicle A performs a calibration process for a sensor mounted on the vehicle A as necessary.

That is, as described above with reference to the flowchart illustrated in FIG. 11, for example, in a case where it is determined in step S121 of the flow illustrated in FIG. 11 that the partner device that has executed the distance comparison process is the infrastructure, the calibration process of the sensor mounted on the vehicle A is performed.

The sensor calibration process is executed according to, for example, the sequence illustrated in the flowchart illustrated in FIG. 12 described above.

### (Case 3) Communication Sequence Example 2 Between Vehicle A and Infrastructure

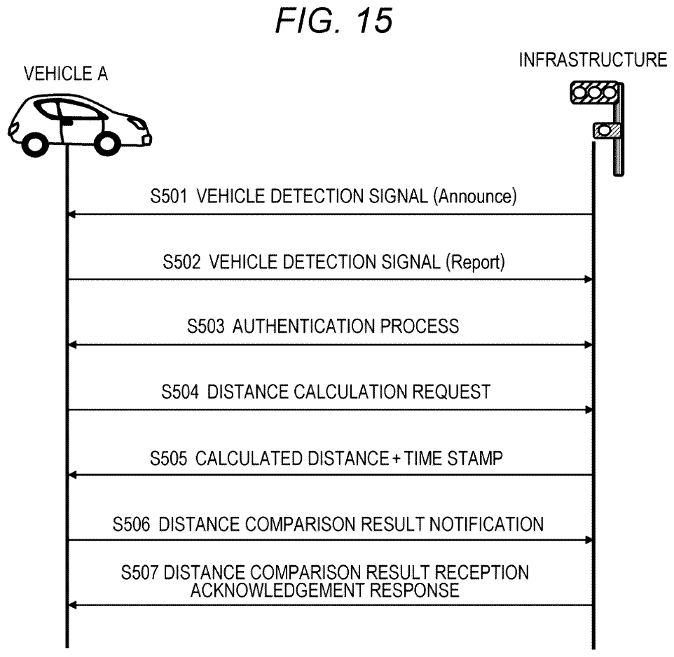

Next, as (Case 3), an example 2 of a communication sequence between the vehicle A and the infrastructure will be described with reference to the sequence diagram illustrated in FIG. 15 in a case where communication is performed between the vehicle A and the infrastructure which is a road facility such as a traffic light, a distance between the vehicle A and the infrastructure is calculated at the same timing in both the vehicle A and the infrastructure, and the vehicle A performs processing of comparing these two calculated distances.

The example 2 is an example in which the communication processing is performed between the vehicle A and the infrastructure similarly to the sequence described above with reference to FIG. 14.

In the sequence described above with reference to FIG. 14, first, the vehicle A transmits the detection signal to the infrastructure capable of measuring the distance.

On the other hand, the example illustrated in FIG. 15 is a sequence in which the infrastructure causes the vehicle approaching the infrastructure to mainly execute distance measurement and comparison process.

In FIG. 15, the vehicle A is illustrated on the left side, and the infrastructure is illustrated on the right side.

Communication processing between the vehicle and the infrastructure is executed according to the sequence of steps S501 to S507 illustrated in FIG. 15.

Hereinafter, the processing of each step is described in order.

### (Step S501)

First, in step S501, the infrastructure transmits a vehicle detection signal (Announce) to a vehicle near the infrastructure approaching the infrastructure.

As the vehicle detection signal (Announce), a signal similar to the vehicle detection signal (Announce) in the communication sequence between the vehicles A and B described above with reference to FIG. 13 can be used.

The vehicle detection signal (Announce) is an announcement signal for detecting a vehicle approaching the infrastructure, and is not a transmission signal for a specific vehicle. A signal directed to an unspecified vehicle, for example, a broadcast signal, is transmitted.

### (Step S502)

Upon receiving the vehicle detection signal (Announce) transmitted by the infrastructure, the vehicle A transmits a response (vehicle detection signal (Report)), which is a response signal indicating that the vehicle detection signal (Announce) has been received from the infrastructure, to the infrastructure in step S502.

### (Step S503)

Next, the infrastructure that has received the response signal (vehicle detection signal (Report)) from the vehicle A starts the authentication process between the vehicle A and the infrastructure in step S503.

In this authentication process, the vehicle A and the infrastructure perform, for example, an ID exchange process as a confirmation process that the vehicle A and the infrastructure performing communication are a mutually reliable vehicle and infrastructure, a sharing process of key data and the like applied to an encryption process of communication data, and the like.

When the authentication is established, the process proceeds to the next step.

In a case where the authentication is not established, the subsequent processing is not executed.

(Step S504) When the authentication process is established in step S503, the vehicle A then transmits a distance calculation request to the infrastructure in step S504. That is, it is requested to execute the calculation process of the distance between the vehicle A and the infrastructure.

### (Step S505)

In step S505, the infrastructure that has received the distance calculation request transmitted by the vehicle A executes a distance calculation process between the vehicle A and the infrastructure, and transmits the calculated vehicle-infrastructure distance data and a time stamp indicating the distance calculation time to the vehicle A.

### (Step S506)

Upon receiving the vehicle-infrastructure distance data (external device calculated distance data D2) and the time stamp indicating the distance calculation time from the infrastructure, the vehicle A selects the own device calculated distance data D1 in which the same time stamp as the time stamp received from the infrastructure is set from the distance data (own device calculated distance data D1) between the vehicle A and the infrastructure already calculated on the vehicle A side, and compares the selected data with the external device calculated distance data D2 received from the infrastructure.

In step S506, the vehicle A transmits the comparison result to the infrastructure.

The notification processing of the distance comparison result information from the vehicle A to the infrastructure corresponds to the processing of step S110 and the processing of step S112 of the flowchart described above with reference to FIG. 8.

That is, in step S109 of the flowchart described with reference to FIG. 8, notification processing of different distance comparison result information is executed according to whether or not the difference between the own device calculated distance data D1 and the external device calculated distance data D2 is less than the defined threshold.

In a case where the difference between the own device calculated distance data D1 calculated by the vehicle A and the external device calculated distance data D2 calculated by the infrastructure is less than the defined threshold, the processing of step S110 of the flowchart described above with reference to FIG. 8 is executed.

In this case, the vehicle A notifies the infrastructure that has transmitted the external device calculated distance data D2 that the difference between the calculated distance data (D1, D2) of both, that is, the vehicle A and the infrastructure is less than the threshold.

On the other hand, in a case where the difference between the own device calculated distance data D1 calculated by the vehicle A and the external device calculated distance data D2 calculated by the infrastructure is not less than the defined threshold, the processing in step S112 of the flowchart described above with reference to FIG. 8 is executed.

In this case, the vehicle A notifies the infrastructure that has transmitted the external device calculated distance data D2 that the difference between the calculated distance data (D1, D2) of both, that is, the vehicle A and the infrastructure is not less than the threshold.

### (Step S507)

Upon receiving the notification of the own device calculated distance data D1, the external device calculated distance data D2, and the distance comparison result information from the vehicle A, the infrastructure transmits, to the vehicle A, an acknowledgement response indicating that the distance comparison result information has been received.

As described above, the communication processing in steps S501 to S507 is executed between the vehicle A and the infrastructure.

After these communication processes, the vehicle A performs a calibration process for a sensor mounted on the vehicle A as necessary.

That is, as described above with reference to the flowchart illustrated in FIG. 11, for example, in a case where it is determined in step S121 of the flow illustrated in FIG. 11 that the partner device that has executed the distance comparison process is the infrastructure, the calibration process of the sensor mounted on the vehicle A is performed.

The sensor calibration process is executed according to, for example, the sequence illustrated in the flowchart illustrated in FIG. 12 described above.

### 5. (Second Embodiment) Embodiment in which Calibration is Performed without Recording Image that is Sensor Detection Information at Time of Distance Measurement

Next, as a second embodiment, an embodiment in which calibration is performed without recording an image that is sensor detection information at the time of distance measurement will be described.

In the above-described embodiment (first embodiment), the sensor detection value when the distance between the vehicles or between the vehicle and the infrastructure is calculated, for example, the LR image captured by the stereo camera is stored in the memory 104, and the sensor calibration process is performed using the recorded image.

The second embodiment described below is an embodiment in which sensor detection values when the distance between the vehicles or between the vehicle and the infrastructure is calculated, for example, captured images from two different viewpoints captured by a stereo camera, that is, an L image which is a captured image from a left viewpoint and an R image which is a captured image from a right viewpoint, and these LR images are not stored in the memory 104.

That is, in the embodiment described below, the sensor calibration process is executed without using an image.

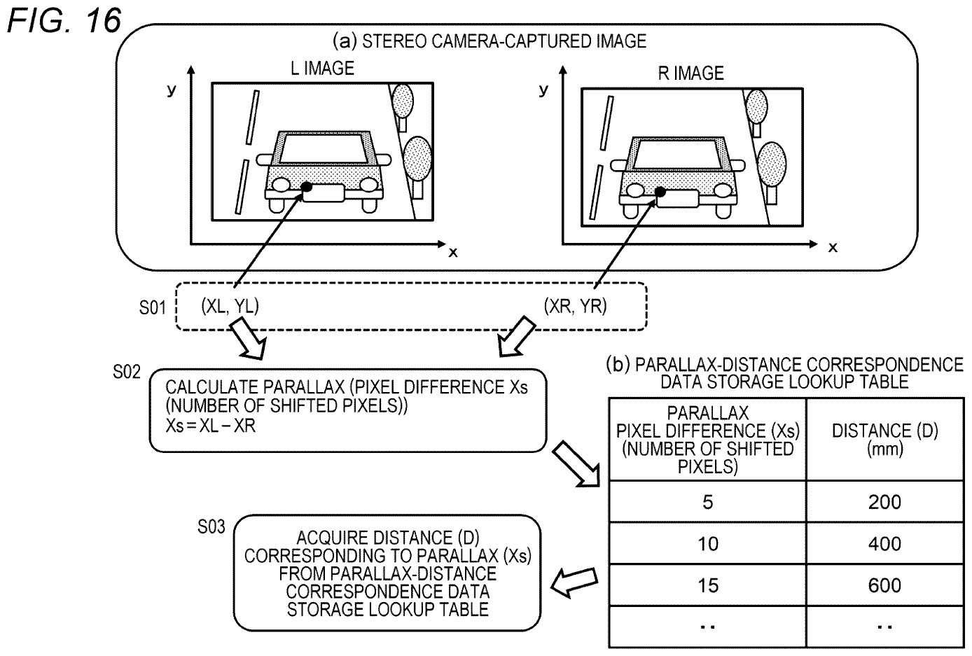

A process of the second embodiment in which the LR image captured by the stereo camera is not stored in the memory 104 will be described with reference to FIG. 16.

(a) Stereo camera-captured image illustrated in FIG. 16 is, for example, an L image and an R image which are two images captured by the sensor 101 of the sensor verification device 100 of the vehicle A, 10 and having different viewpoints.

The distance to the front vehicle that is the subject is calculated using these two images.

In the first embodiment described above, as described above with reference to FIG. 9, the own device calculated distance data D1 which is the calculated distance data and the image data applied to the distance calculation are also stored in the memory 104.

As described above with reference to step S201 of the flowchart illustrated in FIG. 12, the image recorded in the memory 104 is used for the calibration process of the sensor 101 executed in the vehicle A, 10.

In the present second embodiment, these pieces of image data are not recorded in the memory.

In the present second embodiment, the modification process of the lookup table stored in the memory 104 and illustrated in the lower right of FIG. 16 is executed.

That is, in the sensor calibration process, the modification process of “(b) parallax-distance correspondence lookup table” illustrated in the lower right of FIG. 16 is executed.

“(b) Parallax-distance correspondence lookup table” illustrated in the lower right part of FIG. 16 is a table in which the parallax (the number of shifted pixels of the same subject) of the LR image corresponding to the detection value of the sensor 101 (stereo camera) is associated with the distance value corresponding to each parallax.

In general, in a case where the subject distance is calculated from the L image and the R image captured by the sensor 101 which is a stereo camera, the processing of steps S01 to S03 illustrated in FIG. 16 is performed.

First, in step S01, the pixel position of the subject as the distance calculation target is acquired from each of the L image and the R image captured by the sensor 101 as the stereo camera.

In the example illustrated in the drawing, the upper left end of the license plate of the vehicle is set as the distance calculation target subject.

The pixel coordinates of the upper left end of the license plate of the vehicle in the L image are (XL, YL).

On the other hand, the pixel coordinates of the upper left end of the license plate of the vehicle of the R image are (XR, YR).

Since the L image and the R image are captured images from different viewpoint positions, the pixel coordinate positions of the LR image are slightly different.

The positional deviation (parallax) of the pixel coordinates decreases as the distance from the camera to the subject increases. On the other hand, the positional deviation (parallax) of the pixel coordinates increases as the distance from the camera to the subject is shorter. A method of calculating the distance of the subject on the basis of the amount of positional deviation (parallax) of the pixels is a subject distance calculation method using a stereo image.

In the example illustrated in FIG. 16, as illustrated in step S02 in FIG. 16, the parallax Xs at the upper left end of the license plate of the vehicle in each LR image is calculated by the following formula.

$$Xs = XL - XR$$

Next, as illustrated in step S03 of FIG. 16, on the basis of the parallax Xs calculated in step S02, the subject distance corresponding to the parallax Xs is extracted from “(b) parallax-distance correspondence lookup table” illustrated in the lower right of FIG. 16.

According to such a procedure, the distance of the subject included in the LR image can be calculated using the LR image that is the detection value of the sensor 101 and the parallax-distance correspondence lookup table.

Note that the method of calculating the distance to the subject is not limited to the method using the parallax-distance correspondence lookup table, and for example,

D(distance to subject)=B(base length)×f(focal length)/S(parallax)
it may be obtained from the above calculation.

In the present second embodiment, for example, the distance between the vehicles A and B and the LR image used for calculating the distance between the vehicle A and the infrastructure are not stored in the memory 104.

The distance between the vehicles A and B instead of the image, the parallax Xs acquired from the LR image at the time of calculating the distance between the vehicle A and the infrastructure, that is, the parallax amount of each LR image of the subject to be the distance calculation target,

$$Xs = XL - XR$$

this parallax amount is stored in the memory 104.

In executing the calibration process, the modification process of “(b) parallax-distance correspondence lookup table” is executed using the parallax amount (Xs) stored in the memory 104, the correct distance data, for example, the correct distance data (the external device calculated distance data D2) acquired from the external device (vehicle B, infrastructure, or the like), and “(b) parallax-distance correspondence lookup table” illustrated in the lower right part of FIG. 16 stored in the memory 104 in advance.

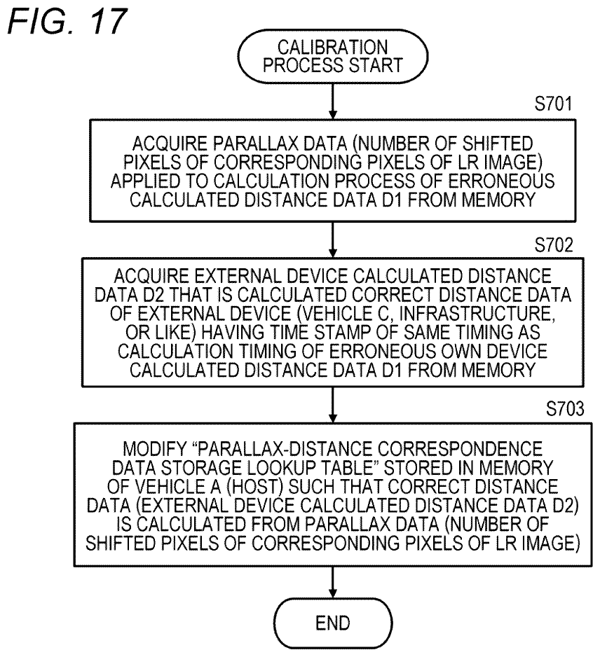

A sequence of a sensor calibration process in the present second embodiment will be described with reference to a flowchart illustrated in FIG. 17.

The flowchart illustrated in FIG. 17 is executed in place of the flowchart illustrated in FIG. 12 executed in the embodiment (first embodiment) described above.

In the flowchart illustrated in FIG. 12 described above, the sensor detection data (stereo LR image) stored in the memory 104 is acquired in step S201, and the calibration process of the sensor 101 is executed.

In the present second embodiment, the calibration process of the sensor 101 is executed without using the LR image.

Note that the calibration process according to the flowchart illustrated in FIG. 17 is a process in which the process according to the flow illustrated in FIGS. 7, 8, and 11 described above is performed and executed as the calibration process in step S123 of the flow illustrated in FIG. 11.

Note that, in the present second embodiment, in step S105 of the flow illustrated in FIG. 7, the storage processing of the image (L image, R image) acquired as the sensor detection value in the memory is not performed.

In the present second embodiment, the parallax Xs acquired from the image (L image, R image) as the sensor detection value in step S105, that is, the parallax amount of each LR image of the subject to be the distance calculation target,

$$Xs = XL - XR$$

this parallax amount is stored in the memory 104 together with a time stamp indicating acquisition timing of the sensor detection value (stereo image).

The calibration process according to the flow illustrated in FIG. 17 is performed in a case where it is determined to execute the calibration process of step S123 as a result of the determination processes of steps S121 and S122 of the flow illustrated in FIG. 11.

That is, the processing is executed in a case corresponding to any one of the following two cases.

(Case 1) A case where it is determined in step S121 that the external device for which the external device calculated distance data D2 has been calculated is an external device (an infrastructure or the like managed by a management server) capable of calculating a high reliability distance.

(Case 2) A case where the number of consecutive times of the distance comparison process in which the difference equal to or greater than the threshold has occurred has reached a defined number=N in step S122.

In a case where any of these cases occurs, the sensor verification device 100 of the vehicle A determines that the calculated distance on the own device, that is, the vehicle A side, that is, the own device calculated distance data D1 is incorrect, and proceeds to step S123 to execute calibration of the sensor 101 of the own device (vehicle A).

The flow illustrated in FIG. 17 is a detailed sequence of the calibration process in step S123.

The flowchart illustrated in FIG. 17 is processing executed by the calibration execution unit 113 of the data processing unit 102 of the sensor verification device 100 of the vehicle A.

Hereinafter, processing of each step of the flow illustrated in FIG. 17 will be sequentially described.

### (Step S701)

The calibration execution unit 113 of the data processing unit 102 of the sensor verification device 100 of the vehicle A first executes the following processing in step S701.

The parallax data Xs calculated on the basis of the image (L image, R image) that is the sensor detection value applied to the calculation process of the own device calculated distance data D1 that is determined to be the erroneous calculated distance data, that is, the parallax data of each LR image of the subject (vehicle B or infrastructure) that is the distance calculation target,

$$Xs = XL - XR$$

this parallax data Xs (the number of shifted pixels) is acquired from the memory 104.

Specifically, the parallax data Xs corresponds to, for example, the number of shifted pixels between the pixel positions (XL, YL) and (XR, YR) in the same subject region of the L image and the R image which are (a) stereo camera images illustrated in FIG. 16.

The parallax data Xs (the number of shifted pixels) is acquired from the memory 104.

### (Step S702)

Next, the calibration execution unit 113 of the data processing unit 102 of the sensor verification device 100 of the vehicle A executes the following processing in step S702.

External device calculated distance data D2 estimated to be correct distance data calculated by an external device (vehicle B, infrastructure, or the like) having a time stamp at the same timing as the erroneous calculation timing of the own device calculated distance data D1 is acquired from the memory.

As described above with reference to FIG. 10, the memory 104 stores reception data from an external device. That is, the memory 104 stores the following data received from the external device.
(b1) External device identifier (ID)
(b2) Time stamp
(b3) External device calculated distance data D2

In step S702, the calibration execution unit 113 selects, from the plurality of entries (p), (q), (r), . . . illustrated in FIG. 10, an entry in which a time stamp at the same time as the time stamp recorded in the memory 104 is set in correspondence with the parallax data Xs (the number of shifted pixels) acquired from the memory 104 in the previous step S701, and acquires the external device calculated distance data D2 recorded in the selected entry.

The external device calculated distance data D2 of the selected entry is distance data calculated by the external device at exactly the same timing as the capturing timing of the stereo image for which the parallax data Xs (the number of shifted pixels) acquired from the memory 104 in the previous step S701 is calculated, and is distance data estimated to be correct distance data.

### (Step S703)

Next, the calibration execution unit 113 of the data processing unit 102 of the sensor verification device 100 of the vehicle A executes the following processing in step S703.

The “parallax-distance correspondence data storage lookup table” stored in the memory 104 of the vehicle A (host) is corrected such that correct distance data (the external device calculated distance data D2) is calculated from the parallax data Xs (the number of shifted pixels) acquired from the memory 104 in step S701 described above.

The “parallax-distance correspondence data storage lookup table” stored in the memory 104 of the vehicle A (host) is corrected by the calibration process according to the sequence illustrated in FIG. 17, and thereafter, the correct distance can be calculated on the basis of the parallax calculated from the stereo image (the L image and the R image) by using the corrected “parallax-distance correspondence data storage lookup table”.

### 6. (Third Embodiment) Embodiment Using Monocular Camera as Sensor

Next, as a third embodiment, an embodiment using a monocular camera as a sensor will be described.

In the first and second embodiments described above, for example, an example in which a stereo camera is used as the sensor 101 that detects the distance in the sensor verification device 100 of the vehicle A, 10 has been described.

As described above with reference to FIG. 4 and the like, the sensor is not limited to a stereo camera, and various sensors capable of measuring a distance can be used.

For example, a light detection and ranging (LiDAR) sensor, a time of flight (ToF) sensor, a sensor such as a millimeter wave radar, a monocular camera, or the like can also be used.

Note that a light detection and ranging (LiDAR) sensor, a ToF sensor, and a millimeter wave radar are sensors that output light such as laser light, for example, and analyze reflected light by an object to measure a distance to a surrounding object.

Hereinafter, as the third embodiment, an embodiment in which an object distance is calculated using a monocular camera will be described.

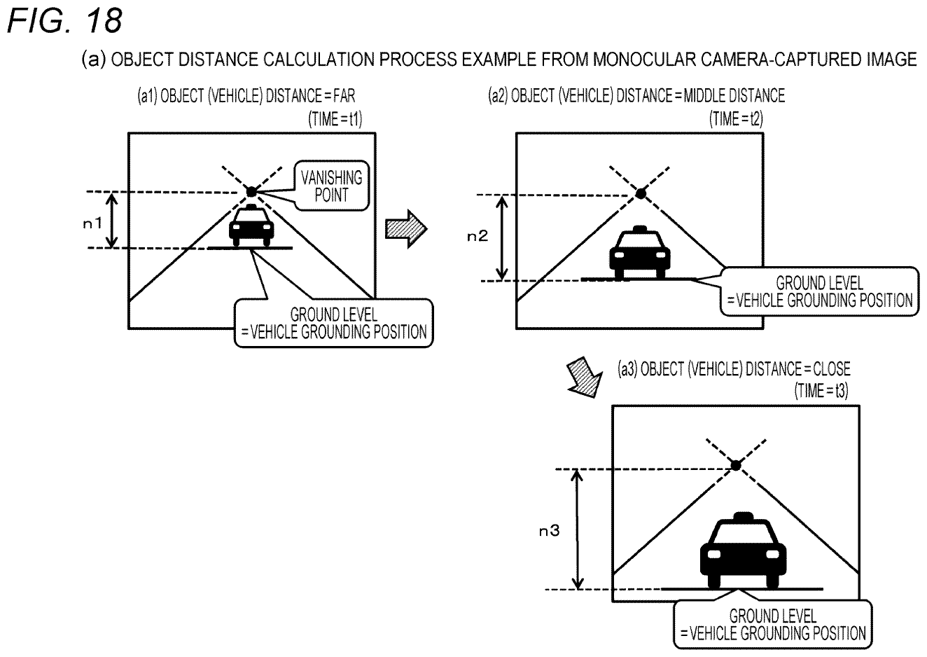

Details of processing of calculating the object distance from the captured image of the monocular camera will be described with reference to FIG. 18.

FIG. 18 illustrates three time-series images (a1), (a2), and (a3) captured by the monocular camera. (a1) is a captured image at time t1, (a2) is a captured image at subsequent time t2, and (a3) is a captured image at subsequent time t3. An image of the vehicle gradually approaching with the lapse of time is captured.

A vanishing point is detected in each image. The vanishing point is a point at infinity where parallel line segments intersect in the captured image in the real world, and is also called an infinite point (FOE: Focus of Expansion). The vanishing point is a point uniquely determined with respect to the optical axis of the camera.

The number of pixels from the vanishing point detected from the image captured by the monocular camera to the grounding position (ground level) of the object as the distance calculation target, for example, the vehicle in each image illustrated in FIG. 18, that is, the number of pixels between the vanishing point and the object grounding position varies depending on the distance from the camera to the object (vehicle).

For example, in the image at (a1) time t1 illustrated in FIG. 18, the number of pixels between the vanishing point and the object grounding position is n1.

In addition, in (a2) image at time t2, the number of pixels between the vanishing point and the object grounding position is n2.

Furthermore, in (a3) image at time t3, the number of pixels between the vanishing point and the object grounding position is n3.

As described above, as the object (vehicle) in the image captured by the monocular camera as the sensor approaches the sensor (monocular camera), the number of pixels between the vanishing point and the object grounding position gradually increases to n1, n2, and n3.

As understood from each image illustrated in FIG. 18, the number of pixels from the vanishing point position to the object grounding position in the captured image of the monocular camera and the distance between the monocular camera and the object are in a one-to-one relationship.

That is, the distance from the monocular camera to the object can be calculated on the basis of the number of pixels from the vanishing point position to the object grounding position in the captured image of the monocular camera.

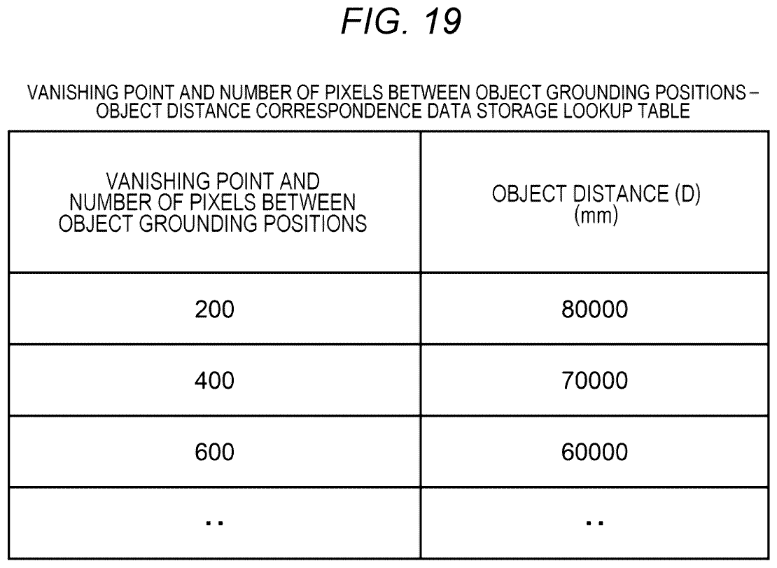

FIG. 19 is a diagram illustrating an example of a lookup table in which a correspondence relationship between the number of pixels from the vanishing point position to the object grounding position in the captured image of the monocular camera and the distance from the monocular camera to the object is recorded.

For example, this lookup table is stored in the memory 104 of the sensor verification device 100 of the vehicle A, 10.

The distance calculation unit 111 in the data processing unit 102 of the sensor verification device 100 of the vehicle A, 10 inputs the captured image of the monocular camera which is the sensor 101, detects the vanishing point from the captured image, and calculates the number of pixels from the vanishing point position to the object grounding position.

Furthermore, the distance calculation unit 111 calculates the distance to the object on the basis of the calculated number of pixels using the lookup table stored in the memory 104, that is, the lookup table illustrated in FIG. 19.

As described above, the object distance can be calculated even in the configuration using the monocular camera as the sensor 101.

### 7. (Fourth Embodiment) Embodiment in which Marker is Set to Clarify Distance Calculation Target Position

Next, as a fourth embodiment, an embodiment in which a marker is set to clarify a distance calculation target position will be described.

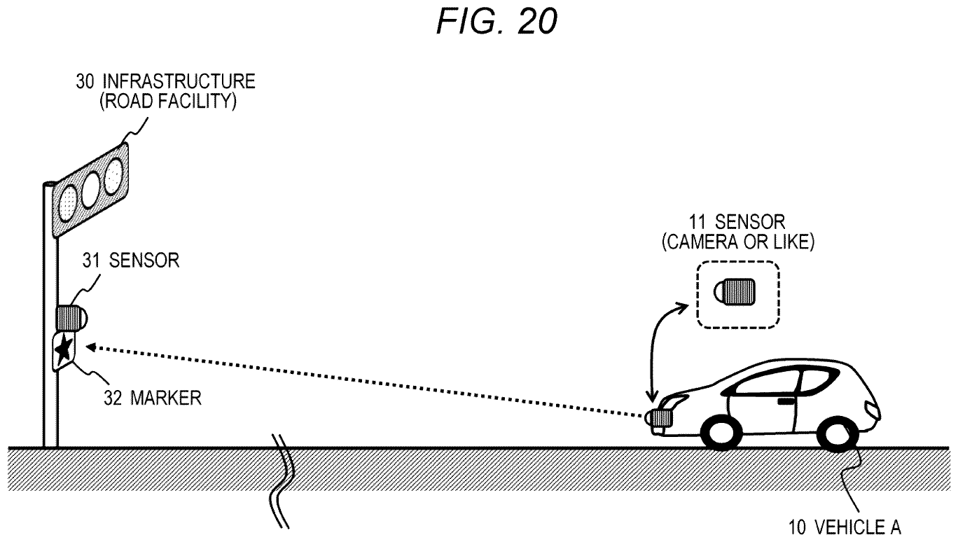

A specific example in which the marker is set to clarify the distance calculation target position will be described with reference to FIG. 20.

FIG. 20 illustrates the vehicle A, 10 and a traffic light as an example of the infrastructure (road facility) 30.

The vehicle A, 10 is mounted with the sensor 11 that detects distances to various objects existing in the front direction of the vehicle A, 10.

The sensor 31 that detects distances to various objects existing around the infrastructure (road facility) 30 is also attached to the infrastructure (road facility) 30.

These sensors 11 and 31 are, for example, stereo cameras.

Both the vehicle A, 10 and the infrastructure (road facility) 30 calculate the distance between the vehicle and the infrastructure at the same timing.

Further, the vehicle A, 10 compares the distance calculated by the vehicle A, 10, that is, the own device calculated distance data D1 with the distance calculated by the infrastructure 30, that is, the external device calculated distance data.

Here, it is necessary for two devices, that is, the vehicle A, 10 and the infrastructure (road facility) 30, to perform distance calculation in which the same two measurement targets are set.

For example, the value of the calculated distance differs depending on which point of the infrastructure (road facility) 30 such as a traffic light is set as the distance calculation target.

In order to prevent such a problem, a marker 32 indicating a distance calculation point is set in the infrastructure (road facility) 30.

The vehicle A, 10 is only required to calculate the distance from the vehicle A, 10 to the marker 32.

Note that FIG. 20 illustrates an example in which the marker 32 is set in the infrastructure 30, but the marker may also be set on the vehicle A, 10 side.

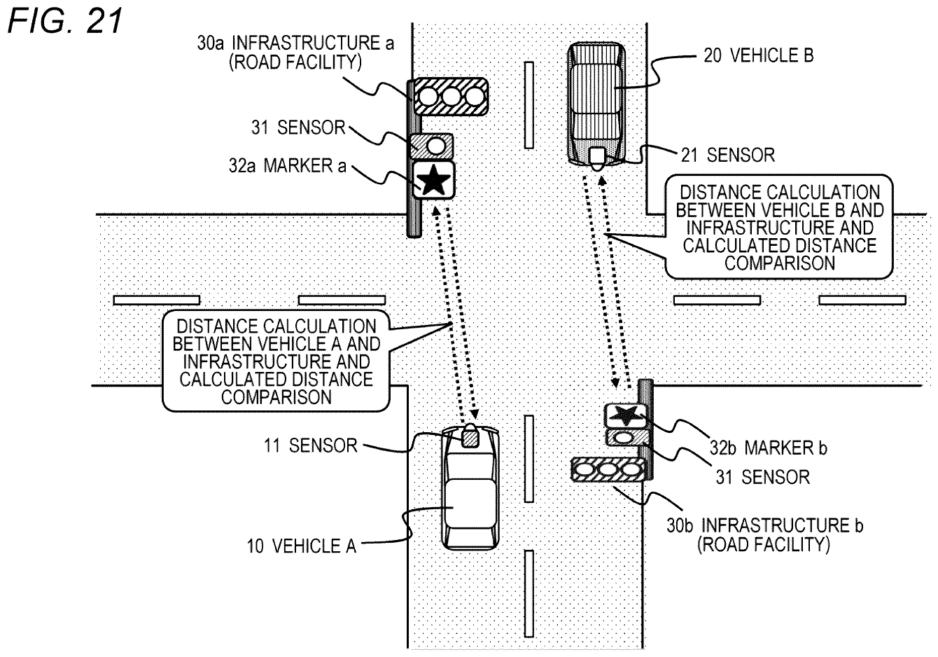

An example of a distance calculation process in a case where the marker 32 indicating the distance measurement position is set in the infrastructure 30 will be described with reference to FIG. 21.

FIG. 21 illustrates the infrastructure a, 30a and the infrastructure b, 30b as two traffic lights installed at intersections.

Two vehicle A, 10 and vehicle B, 20 are stopped at the intersection.

The vehicle A, 10 communicates with the infrastructure a, 30a in front of the vehicle A, 10, and calculates the distance between the vehicle A and the infrastructure a in both.

The vehicle A, 10 detects the marker 32a of the infrastructure a, 30a and calculates the distance between the head of the vehicle A, 10 and the marker a 32 a.

The infrastructure a, 30a side also calculates the distance between a marker a, 32a and the head of the vehicle A, 10 using the reference position of the own device as the marker a, 32 a.

By setting the markers in this manner, the calculated distance targets of both the vehicle A, 10a and the infrastructure a, 30a can be matched, and more accurate comparison process of the calculated distances can be performed.

Note that the comparison process between the calculated distance of the vehicle A, 10 and the calculated distance on the infrastructure a, 30a side may be executed on the vehicle A, 10 side or may be executed on the infrastructure a, 30a side.

However, the device that has performed the comparison process notifies the device side that has not performed the comparison process of the comparison result.

Similarly, the vehicle B, 20 executes communication with the infrastructure b, 30b in front of the vehicle B, 20, and calculates the distance between the vehicle B and the infrastructure b in both.

The vehicle B, 20 detects the marker 32b of the infrastructure b, 30b and calculates the distance between the head of the vehicle B, 20 and the marker b, 32b.

The infrastructure b, 30b side also calculates the distance between the marker b, 32b and the head of the vehicle B, 20 using the reference positions of the own devices as the markers b, 32b.

By setting the markers in this manner, the calculated distance targets of both the vehicle B, 20b and the infrastructure b, 30b can be matched, and the comparison process of the calculated distances can be performed with higher accuracy.

Note that the comparison process between the calculated distance of the vehicle B, 20 and the calculated distance of the infrastructure b, 30b may be executed on the vehicle B, 20 side or may be executed on the infrastructure b, 30b side.

However, the device that has performed the comparison process notifies the device side that has not performed the comparison process of the comparison result.

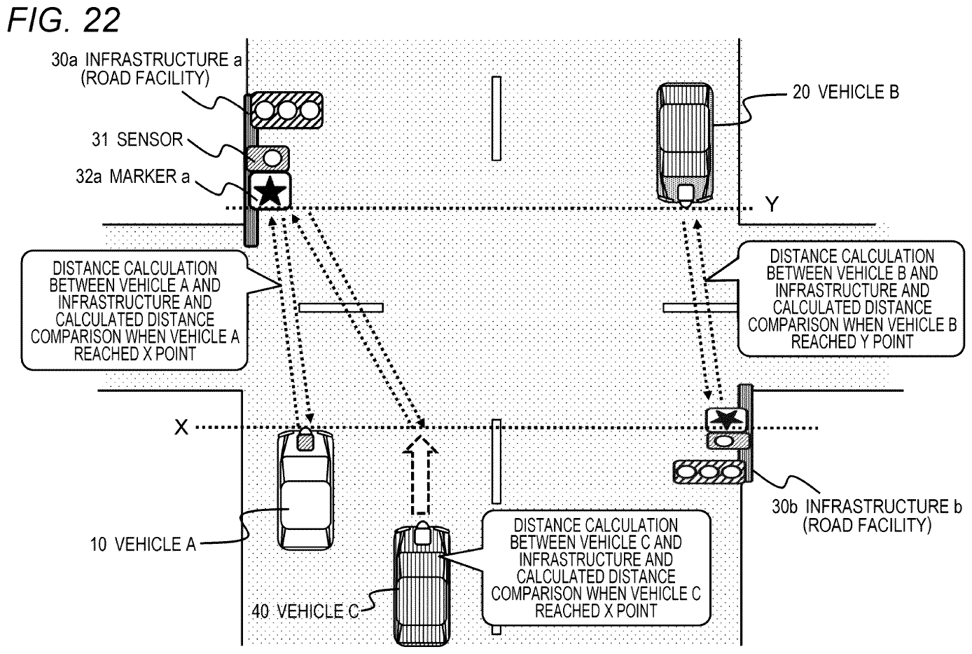

FIG. 22 illustrates an example in which the distance calculation section between the vehicle and the infrastructure is set at positions predefined in the vicinity of the marker and the intersection set in the infrastructure, that is, lines X and Y illustrated in the drawing.

For example, as illustrated in FIG. 22, the infrastructure a, 30a has a marker a, 32a.

Further, a line X and a line Y are set at the intersection. These lines may be painted on the road as visible lines, but may be set as invisible lines. For example, the infrastructure a, 30a holds distance data to the line X at each position on the road in advance in the memory.

For example, the vehicle A, 10 continuously calculates the distance (own device calculated distance data D1) from the time point when the infrastructure 30a is detected to the marker 32a of the infrastructure a, 30a, and stores the distance in the memory in association with the time stamp. The memory also stores distance data (own device calculated distance data D1) calculated at the time of passing through the line X in association with the time stamp.

On the other hand, when the vehicle A, 10 reaches the line X, the infrastructure a, 30a calculates distance data (external device calculated distance data D2) from the marker a, 32a to each vehicle position on the line X, and transmits the distance data to the vehicle A, 10 together with a time stamp indicating the distance calculation timing.

The vehicle A, 10 acquires the external device calculated distance data D2 received from the infrastructure a, 30a and the time stamp received together with the external device calculated distance data D2, and acquires from the memory the own device calculated distance data D1 associated with the time stamp matching the time stamp to compare.

That is, the sensor verification device 100 of the vehicle A, 10 determines whether or not a difference between the two pieces of distance data, the own device calculated distance data D1 and the external device calculated distance data D2 is less than a predefined threshold (Th).

$$\vert D 1 - D 2 \vert < Th$$

It is determined whether or not the above determination formula is satisfied.

In a case where it is determined that the above determination formula is satisfied, it is determined that the own device calculated distance data D1 calculated by the vehicle A and stored in the memory in the sensor verification device 100 of the vehicle A is correct distance data, and the sensor 101 of the sensor verification device 100 and the distance calculation unit 111 of the data processing unit 102 of the vehicle A are normally operating. In this case, it is determined that a calibration process as a correction process of the sensor 101, the distance calculation parameter, and the like is unnecessary.

On the other hand, in a case where it is determined that the above determination formula is not satisfied, that is, in a case where it is determined that the difference between the own device calculated distance data D1 and the external device calculated distance data D2 is not less than the predefined threshold (Th), it is determined that the own device calculated distance data D1 is incorrect distance data, and the sensor 101 of the sensor verification device 100 and the distance calculation unit 111 of the data processing unit 102 of the vehicle A are not normally operating. In this case, it is determined that a calibration process as a correction process of the sensor 101, the distance calculation parameter, and the like is necessary, and the calibration process is executed.

A vehicle C, 40 illustrated in FIG. 22 also executes processing similar to that of the infrastructure a, 30a at the point of reaching the line X.

In addition, the vehicle B, 20 illustrated in FIG. 22 executes processing similar to that of the infrastructure b, 30b at a point where the line Y is reached.

In this way, by using the marker on the infrastructure side and the lines predefined at the intersection, the distance calculation point becomes clear, and more accurate distance calculation and calculated distance comparison process are realized.

### 8. Other Embodiments

Next, other embodiments will be described.

In the above-described embodiments, the embodiments in which the sensor verification device is mounted on an infrastructure (road facility) such as a vehicle and a traffic light have been described.

That is, the embodiments in a case where the sensor verification device having the configuration described above with reference to FIG. 4 is incorporated in an infrastructure (road facility) such as a vehicle or a traffic light have been described.

The sensor verification device having the configuration described with reference to FIG. 4 can be mounted on various devices other than a vehicle and an infrastructure (road facility).

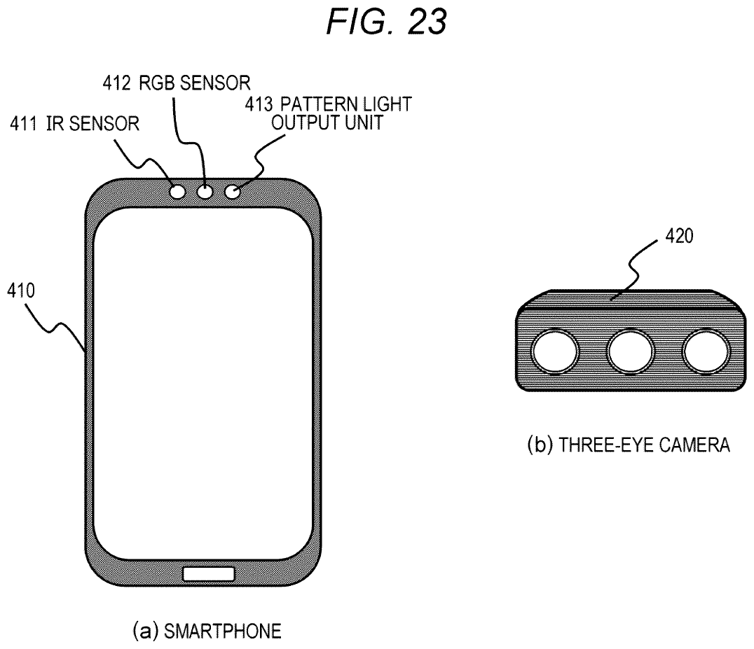

A specific example will be described with reference to FIG. 23.

FIG. 23 illustrates (a) a smartphone and (b) a three-eye camera. For example, the sensor verification device having the configuration described with reference to FIG. 4 may be mounted in a smartphone 410 or a three-eye camera 420 illustrated in FIG. 23.

The smartphone 410 illustrated in FIG. 23 includes an IR sensor 411, an RGB sensor 412, and a pattern light output unit 413. The pattern light output unit 413 emits, for example, a light pattern in a lattice shape or on a stripe. The IR sensor 411 and the RGB sensor 412 capture a subject irradiated with pattern light.

The IR sensor 411 captures an infrared light image, and the RGB sensor 412 captures an RGB color image.

Note that the pattern light output unit 413 selectively outputs infrared light or visible light by a sensor used for image capturing.

Images captured by the IR sensor 411 and the RGB sensor 412 are input to, for example, a distance calculation unit of a data processing unit in the smartphone 410 having a configuration similar to that of the sensor verification device 100 described above with reference to FIG. 4, and the distance calculation unit calculates the distance to the subject.

Furthermore, the three-eye camera 420 illustrated in FIG. 23 is a camera including three imaging units having different viewpoints. By analyzing the captured images from the three different viewpoints, the object distance can be calculated with higher accuracy than the stereo camera with two viewpoints.

Such a stereo camera having three or more viewpoints may be used as the sensor.

### 9. Hardware Configuration Example of Sensor Verification Device of Present Disclosure

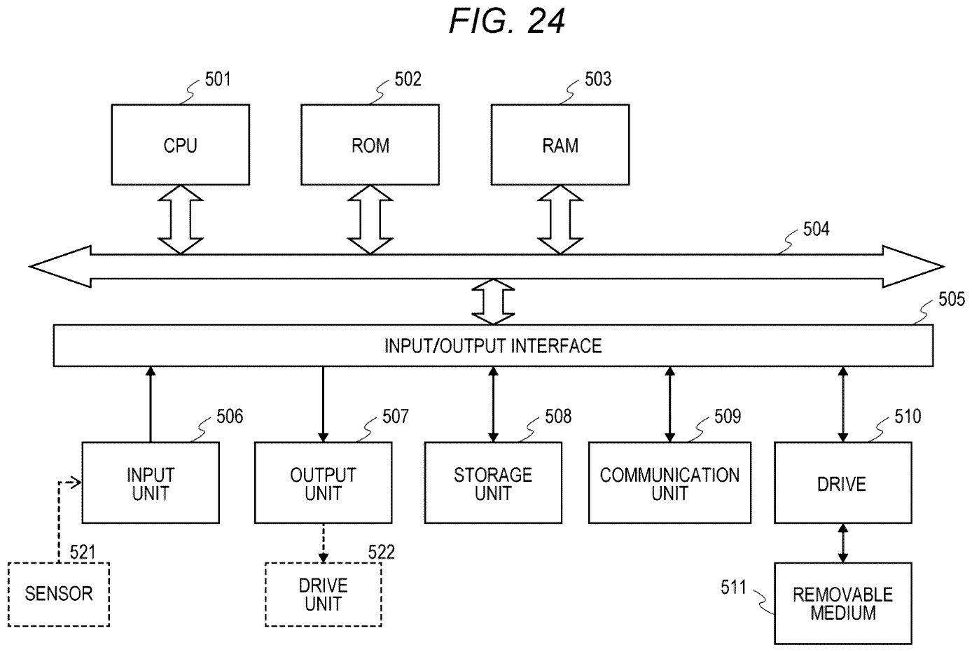

Next, a specific hardware configuration example of the sensor verification device of the present disclosure will be described with reference to FIG. 24.

FIG. 24 is a diagram illustrating an example of a hardware configuration of the sensor verification device 100 of the present disclosure described above with reference to FIG. 4.

Hereinafter, each component of the hardware configuration illustrated in FIG. 24 will be described.

A central processing unit (CPU) 501 functions as a data processing unit that executes various processes according to a program stored in a read only memory (ROM) 502 or a storage unit 508. For example, processes according to the sequence described in the above-described embodiments are executed. A random access memory (RAM) 503 stores a program executed by the CPU 501, data, and the like. The CPU 501, the ROM 502, and the RAM 503 are mutually connected by a bus 504.

The CPU 501 is connected to an input/output interface 505 via the bus 504, and an input unit 506 including various switches, a keyboard, a touch panel, a mouse, a microphone, a sensor such as a camera, a status data acquisition unit such as a GPS, and the like, and an output unit 507 including a display, a speaker, and the like are connected to the input/output interface 505.

Note that input information from a sensor 521 such as a camera is also input to the input unit 506.

In addition, in a case where the sensor verification device is mounted on the vehicle, the output unit 507 also outputs drive information for a drive unit 522 of the vehicle.

The CPU 501 inputs a command, status data, and the like input from the input unit 506, executes various processes, and outputs a processing result to the output unit 507, for example.

The storage unit 508 connected to the input/output interface 505 includes, for example, a hard disk, and the like and stores programs executed by the CPU 501 and various data. A communication unit 509 functions as a data communication transmitting/receiving unit via a network such as the Internet or a local area network, and communicates with an external device.

A drive 510 connected to the input/output interface 505 drives a removable medium 511 such as a magnetic disk, an optical disk, a magneto-optical disk, or a semiconductor memory such as a memory card to record or read data.

### 10. Summary of Configuration of Present Disclosure

As described above, the embodiments of the present disclosure have been described in detail with reference to particular embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.
(1) A sensor verification device including:
a distance calculation unit that calculates a device-to-device distance between an own device and an external device as own device calculated distance data D1 on the basis of a detection value of a sensor;
a communication unit that receives the device-to-device distance calculated by the external device from the external device as external device calculated distance data D2; and
a sensor state determination unit that compares the own device calculated distance data D1 with the external device calculated distance data D2 and determines whether or not the sensor is in a state capable of measuring a correct distance value on the basis of a comparison result.
(2) The sensor verification device according to (1), in which
the sensor state determination unit is configured to
calculate a difference between the own device calculated distance data D1 and the external device calculated distance data D2 calculated at a same timing.
(3) The sensor verification device according to (2), in which
the sensor state determination unit is configured to
acquire calculated distance data at a same timing on the basis of time stamps associated with the own device calculated distance data D1 and the external device calculated distance data D2, and calculate a difference.
(4) The sensor verification device according to any one of (1) to (3), in which
the sensor state determination unit is configured to:
determine whether or not a difference between the own device calculated distance data D1 and the external device calculated distance data D2 is less than a defined threshold; and
determine that the sensor is in a state capable of measuring a correct distance value in a case where the difference is less than the defined threshold.
(5) The sensor verification device according to any one of (1) to (4), in which
the sensor state determination unit is configured to:
determine whether or not a difference between the own device calculated distance data D1 and the external device calculated distance data D2 is less than a defined threshold; and
determine that there is a possibility that the sensor is not in a state capable of measuring a correct distance value in a case where the difference is not less than the defined threshold.
(6) The sensor verification device according to any one of (1) to (5), in which
the sensor state determination unit is configured to:
determine whether or not a difference between the own device calculated distance data D1 and the external device calculated distance data D2 is less than a defined threshold; and
in a case where calculated distance data comparison process with a new external device is executed in a case where the difference is not less than the defined threshold, and in a case where the number of times the difference between calculated distances of the own device and the external device becomes equal to or greater than the threshold continues a predefined number of times,
determine that the sensor is not in a state capable of measuring a correct distance value.
(7) The sensor verification device according to any one of (1) to (6), in which
the sensor verification device is a device mounted on a vehicle, and
the external device is either an external vehicle or an infrastructure as a road facility.
(8) The sensor verification device according to (7), in which
the distance calculation unit is configured to calculate a distance between an own vehicle and an external vehicle or an infrastructure as own device calculated distance data D1 on the basis of a detection value of the sensor, and
the communication unit is configured to receive external device calculated distance data D2 calculated by the external vehicle or the infrastructure from the external device.
(9) The sensor verification device according to according to (7) or (8), in which
the sensor state determination unit is configured to:
determine whether or not a difference between the own device calculated distance data D1 and the external device calculated distance data D2 is less than a defined threshold;
in a case where the difference is not less than the defined threshold,
determine whether the external device is an external vehicle or an infrastructure; and
in a case where the external device is an infrastructure,
determine that the sensor is not in a state capable of measuring a correct distance value.
(10) The sensor verification device according to (9), in which the infrastructure is an infrastructure managed by a management server, and is an infrastructure in which periodic sensor calibration is executed.
(11) The sensor verification device according to any one of (7) to (10), in which
the sensor state determination unit is configured to
notify the external device of a determination result as to whether or not a difference between the own device calculated distance data D1 and the external device calculated distance data D2 is less than a defined threshold via the communication unit.
(12) The sensor verification device according to any one of (1) to (11), in which
the sensor verification device includes
a calibration execution unit that executes a calibration process of the sensor, and
the calibration execution unit is configured to
execute the calibration process of the sensor in a case where the sensor state determination unit determines that the sensor is not in a state capable of measuring a correct distance value.
(13) The sensor verification device according to (12), in which
the calibration execution unit is configured to
execute processing of correcting at least one of an internal parameter or an external parameter of the sensor to bring the sensor into a state capable of measuring a correct distance value.
(14) The sensor verification device according to according to (12) or (13), in which
the sensor is a stereo camera, and
the calibration execution unit is configured to
execute the calibration process using a captured image of a stereo camera and correct distance data stored in a memory.
(15) The sensor verification device according to any one of (12) to (14), in which
the sensor is a stereo camera, and
the calibration execution unit is configured to
execute a correction process of a lookup table that is correspondence data between a parallax and a distance stored in a memory to bring the sensor into a state capable of measuring a correct distance value.
(16) The sensor verification device according to any one of (1) to (15), in which
the sensor is
any one of a stereo camera, a monocular camera, and a distance measuring sensor.
(17) The sensor verification device according to any one of (1) to (16), in which
the distance calculation unit is configured to
calculate a distance between a marker attached to the external device and the own device.
(18) A sensor verification system including an own vehicle and an external device, in which
the external device is either an external vehicle or an infrastructure, and
the own vehicle includes:
a distance calculation unit that calculates a device-to-device distance between the own vehicle and the external device as own device calculated distance data D1 on the basis of a detection value of a sensor;
a communication unit that receives the device-to-device distance calculated by the external device from the external device as external device calculated distance data D2; and
a sensor state determination unit that compares the own device calculated distance data D1 with the external device calculated distance data D2, determines whether or not the sensor is in a state capable of measuring a correct distance value on the basis of a comparison result, and notifies the external device of the comparison result.
(19) A sensor verification method executed in a sensor verification device, the sensor verification method including:
   a distance calculation step of calculating, by a distance calculation unit, a device-to-device distance between an own device and an external device as own device calculated distance data D1 on the basis of a detection value of a sensor;
   a communication step of receiving, by a communication unit, the device-to-device distance calculated by the external device from the external device as external device calculated distance data D2; and
   a sensor state determination step of comparing, by a sensor state determination unit, the own device calculated distance data D1 with the external device calculated distance data D2, and determining whether or not the sensor is in a state capable of measuring a correct distance value on the basis of a comparison result.

Furthermore, a series of processes described herein can be executed by hardware, software, or a configuration obtained by combining hardware and software. In a case of processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed in a computer from the recording medium, a program can be received via a network such as a local area network (LAN) or the Internet and installed in a recording medium such as an internal hard disk or the like.

Note that the various processes described herein may be executed not only in a chronological order in accordance with the description, but may also be executed in parallel or individually depending on processing capability of a device that executes the processing or depending on the necessity. Furthermore, a system herein described is a logical set configuration of a plurality of devices, and is not limited to a system in which devices of respective configurations are in the same housing.

### INDUSTRIAL APPLICABILITY

As described above, according to a configuration of an embodiment of the present disclosure, it is possible to implement a device and a method that enable high-frequency sensor calibration by frequently verifying whether or not a sensor can calculate a normal distance.

Specifically, for example, a distance between an own vehicle and an external vehicle or a distance between an own vehicle and an infrastructure is calculated as own device calculated distance data D1 on the basis of a detection value of a sensor such as a stereo camera, a device-to-device distance calculated by an external device is received from the external device as external device calculated distance data D2, and the own device calculated distance data D1 and the external device calculated distance data D2 are compared to determine whether or not the sensor is in a state capable of measuring a correct distance value on the basis of a comparison result. In a case where it is determined that the sensor is not in a state capable of measuring a correct distance value, a sensor calibration process or a failure detection process is executed.

With this configuration, a device and a method are implemented that enable high-frequency sensor calibration by frequently verifying whether or not a sensor can calculate a normal distance.

### REFERENCE SIGNS LIST

10, 20, 40 Vehicle
11, 21, 31 Sensor
30 Infrastructure
32 Marker
50 Management server
51 Communication network
100 Sensor verification device
101 Sensor
102 Data processing unit
103 Communication unit
104 Memory
105 Position information acquisition unit
111 Distance calculation unit
112 Sensor state determination unit
113 Calibration execution unit
114 Position analysis unit
200 Sensor verification device
201 Sensor
202 Data processing unit
203 Communication unit
204 Memory
205 Position information acquisition unit
300 Sensor verification device
301 Sensor
302 Data processing unit
303 Communication unit
304 Memory
410 Smartphone
411 IR sensor
412 RGB sensor
413 Pattern light output unit
420 Three-eye camera
501 CPU
502 ROM
503 RAM
504 Bus
505 Input/output interface
506 Input unit
507 Output unit
508 Storage unit
509 Communication unit
510 Drive
511 Removable medium
521 Sensor
522 Drive unit

1. A sensor verification device comprising:
a distance calculation unit that calculates a device-to-device distance between an own device and an external device as own device calculated distance data D1 on a basis of a detection value of a sensor;
a communication unit that receives the device-to-device distance calculated by the external device from the external device as external device calculated distance data D2; and
a sensor state determination unit that compares the own device calculated distance data D1 with the external device calculated distance data D2 and determines whether or not the sensor is in a state capable of measuring a correct distance value on a basis of a comparison result.

2. The sensor verification device according to claim 1, wherein
the sensor state determination unit is configured to
calculate a difference between the own device calculated distance data D1 and the external device calculated distance data D2 calculated at a same timing.

3. The sensor verification device according to claim 2, wherein
the sensor state determination unit is configured to
acquire calculated distance data at a same timing on a basis of time stamps associated with the own device calculated distance data D1 and the external device calculated distance data D2, and calculate a difference.

4. The sensor verification device according to claim 1, wherein
the sensor state determination unit is configured to:
determine whether or not a difference between the own device calculated distance data D1 and the external device calculated distance data D2 is less than a defined threshold; and
determine that the sensor is in a state capable of measuring a correct distance value in a case where the difference is less than the defined threshold.

5. The sensor verification device according to claim 1, wherein
the sensor state determination unit is configured to:
determine whether or not a difference between the own device calculated distance data D1 and the external device calculated distance data D2 is less than a defined threshold; and
determine that there is a possibility that the sensor is not in a state capable of measuring a correct distance value in a case where the difference is not less than the defined threshold.

6. The sensor verification device according to claim 1, wherein
the sensor state determination unit is configured to:
determine whether or not a difference between the own device calculated distance data D1 and the external device calculated distance data D2 is less than a defined threshold; and
in a case where calculated distance data comparison process with a new external device is executed in a case where the difference is not less than the defined threshold, and in a case where the number of times the difference between calculated distances of the own device and the external device becomes equal to or greater than the threshold continues a predefined number of times,
determine that the sensor is not in a state capable of measuring a correct distance value.

7. The sensor verification device according to claim 1, wherein
the sensor verification device is a device mounted on a vehicle, and
the external device is either an external vehicle or an infrastructure as a road facility.

8. The sensor verification device according to claim 7, wherein
the distance calculation unit is configured to calculate a distance between an own vehicle and an external vehicle or an infrastructure as own device calculated distance data D1 on a basis of a detection value of the sensor, and
the communication unit is configured to receive external device calculated distance data D2 calculated by the external vehicle or the infrastructure from the external device.

9. The sensor verification device according to claim 7, wherein
the sensor state determination unit is configured to:
determine whether or not a difference between the own device calculated distance data D1 and the external device calculated distance data D2 is less than a defined threshold;
in a case where the difference is not less than the defined threshold,
determine whether the external device is an external vehicle or an infrastructure; and
in a case where the external device is an infrastructure,
determine that the sensor is not in a state capable of measuring a correct distance value.

10. The sensor verification device according to claim 9, wherein the infrastructure is an infrastructure managed by a management server, and is an infrastructure in which periodic sensor calibration is executed.

11. The sensor verification device according to claim 7, wherein
the sensor state determination unit is configured to
notify the external device of a determination result as to whether or not a difference between the own device calculated distance data D1 and the external device calculated distance data D2 is less than a defined threshold via the communication unit.

12. The sensor verification device according to claim 1, wherein
the sensor verification device includes
a calibration execution unit that executes a calibration process of the sensor, and
the calibration execution unit is configured to
execute the calibration process of the sensor in a case where the sensor state determination unit determines that the sensor is not in a state capable of measuring a correct distance value.

13. The sensor verification device according to claim 12, wherein
the calibration execution unit is configured to
execute processing of correcting at least one of an internal parameter or an external parameter of the sensor to bring the sensor into a state capable of measuring a correct distance value.

14. The sensor verification device according to claim 12, wherein
the sensor is a stereo camera, and
the calibration execution unit is configured to
execute the calibration process using a captured image of a stereo camera and correct distance data stored in a memory.

15. The sensor verification device according to claim 12, wherein
the sensor is a stereo camera, and
the calibration execution unit is configured to
execute a correction process of a lookup table that is correspondence data between a parallax and a distance stored in a memory to bring the sensor into a state capable of measuring a correct distance value.

16. The sensor verification device according to claim 1, wherein
the sensor is
any one of a stereo camera, a monocular camera, and a distance measuring sensor.

17. The sensor verification device according to claim 1, wherein
the distance calculation unit is configured to
calculate a distance between a marker attached to the external device and the own device.

18. A sensor verification system including an own vehicle and an external device, wherein
the external device is either an external vehicle or an infrastructure, and
the own vehicle includes:
a distance calculation unit that calculates a device-to-device distance between the own vehicle and the external device as own device calculated distance data D1 on a basis of a detection value of a sensor;
a communication unit that receives the device-to-device distance calculated by the external device from the external device as external device calculated distance data D2; and
a sensor state determination unit that compares the own device calculated distance data D1 with the external device calculated distance data D2, determines whether or not the sensor is in a state capable of measuring a correct distance value on a basis of a comparison result, and notifies the external device of the comparison result.

19. A sensor verification method executed in a sensor verification device, the sensor verification method comprising:
a distance calculation step of calculating, by a distance calculation unit, a device-to-device distance between an own device and an external device as own device calculated distance data D1 on a basis of a detection value of a sensor;
a communication step of receiving, by a communication unit, the device-to-device distance calculated by the external device from the external device as external device calculated distance data D2; and
a sensor state determination step of comparing, by a sensor state determination unit, the own device calculated distance data D1 with the external device calculated distance data D2, and determining whether or not the sensor is in a state capable of measuring a correct distance value on a basis of a comparison result.
